(19) United States
(12) Patent Application Publication
(10) Pub. No.: US 2023/0004414 A1
(43) Pub. Date: Jan. 5, 2023

(54) AUTOMATED INSTANTIATION AND MANAGEMENT OF MOBILE NETWORKS

(71) Applicant: VNware, Inc., Palo Alto, CA (US)

(72) Inventors: Xiaojun Lin, Beijing (CN); Leon Cui, Beijing (CN); Hemanth Kumar Pannem, Palo Alto, CA (US); Xiaoli Tie, Beijing (CN)

(73) Assignee: VNware, Inc., Palo Alto, CA (US)

(21) Appl. No.: 17/367,470

(22) Filed: Jul. 5, 2021

(51) Int. Cl. G06F 9/455; G06F 9/50; H04L 12/24

(52) U.S. Cl. CPC G06F 9/45558; G06F 9/5083; H04L 41/0893; H04L 41/0806; G06F 2009/45595; G06F 2009/4557

(57) ABSTRACT

The current document is directed to methods and subsystems that instantiate and manage mobile-network computational infrastructure. The currently disclosed improved mobile-network-computational-infrastructure orchestration system employs several layers of containerized-application orchestration and management systems. For increased efficiency and security, mobile-network-specific operators are added to the containerized-application orchestration layers in order to extend the functionalities of the containerized-application orchestration layers and move virtualization-layer dependencies from the mobile-network-computational-infrastructure orchestration system down into the containerized-application orchestration layers. The improved mobile-network-computational-infrastructure orchestration system is responsible for generating, from an input mobile-network computational-infrastructure specification, one or more workload resource specifications and a node policy that are input to a containerized-application-orchestration layer. The containerized-application-orchestration layers instantiate and manage worker nodes that execute mobile-network application instances that implement VNFs and CNFs according to the one or more workload resource specifications and the node policy.

### TECHNICAL FIELD

The current document is directed to distributed-computer-systems and, in particular, to methods and subsystems that automatically and efficiently instantiate and manage cloud-based mobile networks.

### BACKGROUND

During the past seven decades. electronic computing has evolved from primitive, vacuum-tube-based computer systems, initially developed during the 1940s, to modern electronic computing systems in which large numbers of multi-processor servers, work stations. and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. However. despite all of these advances, the rapid increase in the size and complexity of computing systems has been accompanied by numerous scaling issues and technical challenges, including technical challenges associated with distributed-system management. As new distributed-computing technologies are developed, and as general hardware and software technologies continue to advance, the current trend towards ever-larger and more complex distributed computing systems appears likely to continue well into the future.

The 5G mobile-network architecture is an example of a complex distributed computing system. 5G mobile networks are rapidly moving towards cloud implementations based on cloud-native network functions (“CNFs”) and virtual network functions (“VNFs”) for many reasons, including reduction of latencies associated with transmission of packets between base-station controllers and core functionalities implemented in centralized data centers, increased flexibility in distributing functionalities among local, regional, and national data centers, and increased ability to rapidly update mobile-network functionalities and implementations. However, due to the great complexity of mobile-and networking systems, instantiation and management of such systems are associated with many technical difficulties and challenges. As cloud-based 5G mobile networks increasingly replace older technologies, vendors, developers, managers, and. ultimately, users of cloud-based 5G mobile networks continue to seek more time-efficient, cost-efficient, and reliable implementations, particularly from the standpoint of mobile-network computational-infrastructure instantiation and subsequent management.

### SUMMARY

The current document is directed to methods and subsystems that instantiate and manage mobile-network computational infrastructure. The currently disclosed improved mobile-network-computational-infrastructure orchestration system employs several layers of containerized-application orchestration and management systems. For increased efficiency and security, mobile-network-specific operators are added to the containerized-application orchestration layers in order to extend the functionalities of the containerized-application orchestration layers and move virtualization-layer dependencies from the mobile-network-computational-infrastructure orchestration system down into the containerized-application orchestration layers. The improved mobile-network-computational-infrastructure orchestration system is responsible for generating. from an input mobile-network computational-infrastructure specification, one or more workload resource specifications and a node policy that are input to a containerized-application-orchestration layer. The containerized-application-orchestration layers instantiate and manage worker nodes that execute mobile-network application instances that implement VNFs and CNFs according to the one or more workload resource specifications and the node policy.

### BRIEF DESCRIPTION OF THE DRAWINGS

FIG. 1 provides a general architectural diagram for various types of computers.

FIG. 2 illustrates an Internet-connected distributed computing system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a VI-management-server and physical servers of a physical data center above which a virtual-data-center interface is provided by the VI-management-server.

FIG. 9 illustrates a cloud-director level of abstraction.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIG. 11 illustrates the Open Systems Interconnection model (“OSI model”) that characterizes many modern approaches to implementation of communications systems that interconnect computers.

FIGS. 12A-B illustrate a layer-2-over-layer-3 encapsulation technology on which virtualized networking can be based.

FIG. 13 illustrates virtualization of two communicating servers.

FIG. 14 illustrates a virtual distributed computer system based on one or more distributed computer systems.

FIG. 15 illustrates a fundamental Kubernetes abstraction.

FIG. 16 illustrates a next level of abstraction provided by Kubernetes, referred to as a “Kubernetes cluster.”

FIG. 17 illustrates the logical contents of a pod.

FIG. 18 illustrates the logical contents of a Kubernetes management node and a Kubernetes worker node.

FIGS. 19A-E illustrate operation of a Kubernetes cluster.

FIG. 20 illustrates the Tanzu Kubernetes Grid (“TKG”) containerized-application orchestration system.

FIG. 21 illustrates an older-technology mobile network.

FIG. 22 illustrates newer-technology mobile network based largely on packet-based-network communications.

FIG. 23 provides a block diagram for the various logical components of a 5G mobile network.

FIG. 24 illustrates the nature of VNF and CNF implementations.

FIG. 25 illustrates the nature of certain mobile-network-application-execution-environment requirements.

FIGS. 26A-H illustrate a current approach to instantiating and managing a mobile network implemented as CNFs and VNFs in multiple distributed computing systems, data centers, and/or cloud-computing facilities.

FIGS. 27A-D illustrate operation of the improved TCA using illustration conventions employed in FIGS. 26A-H, discussed in the previous subsection of this document.

FIGS. 28A-B show an example VMConfig custom resource definition.

FIGS. 29A-D show an example of a NodeConfig custom resource definition.

### DETAILED DESCRIPTION

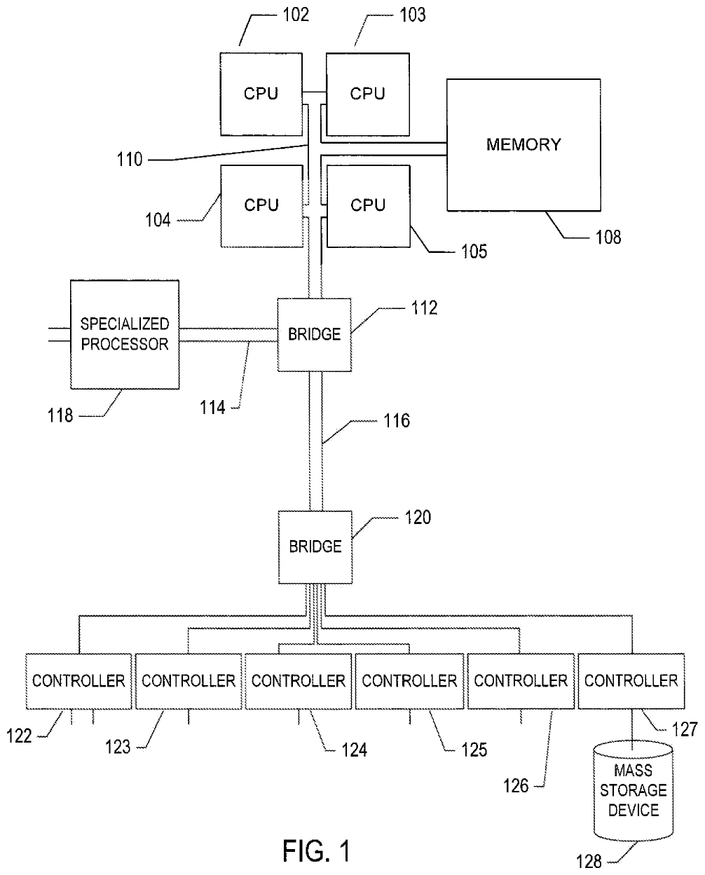

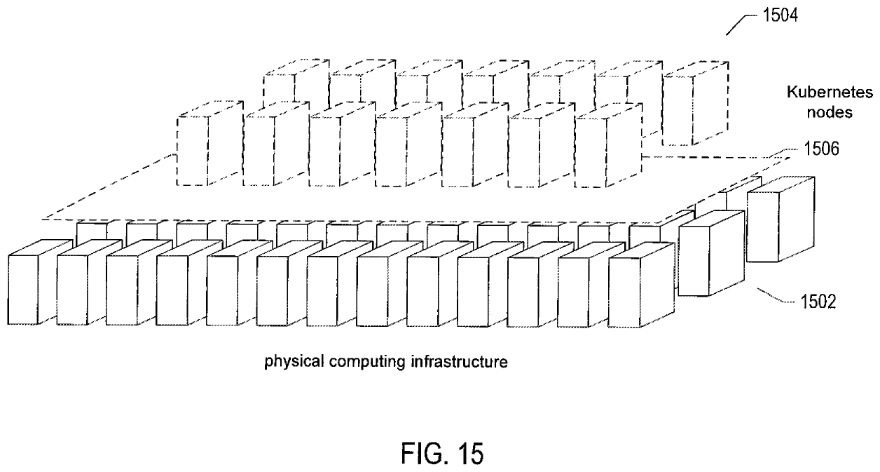

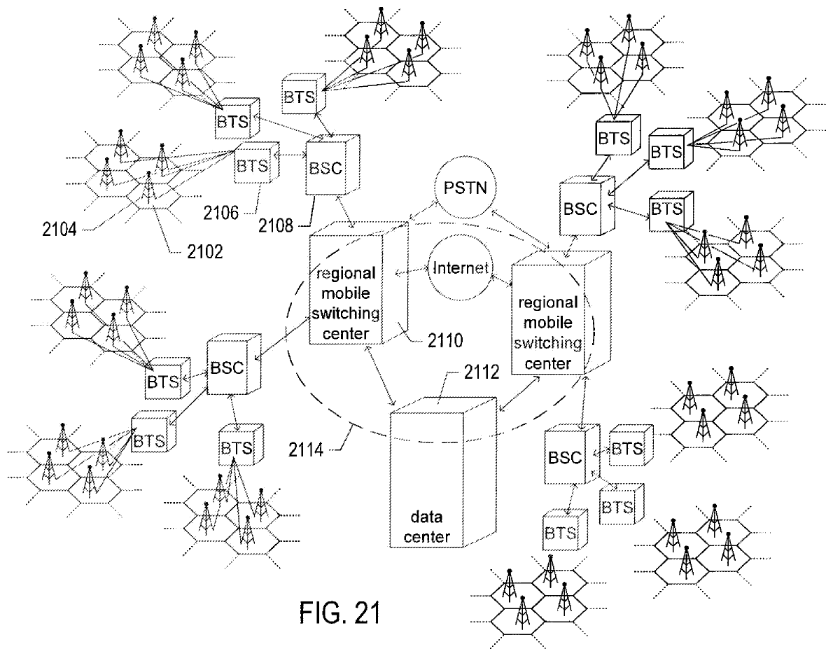

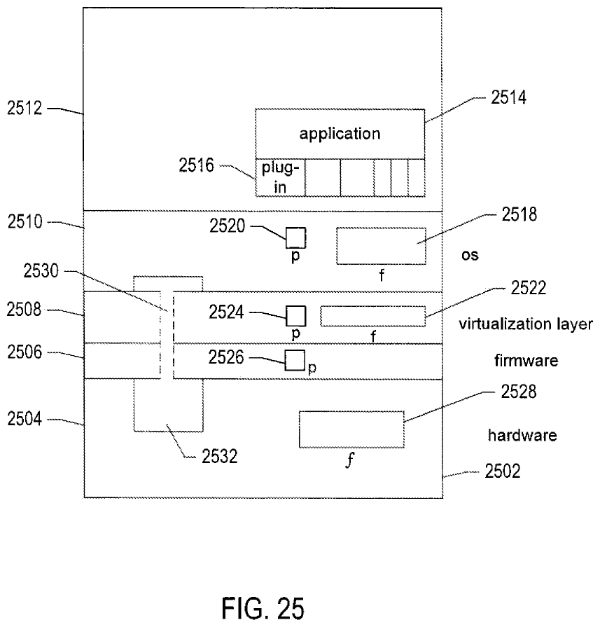

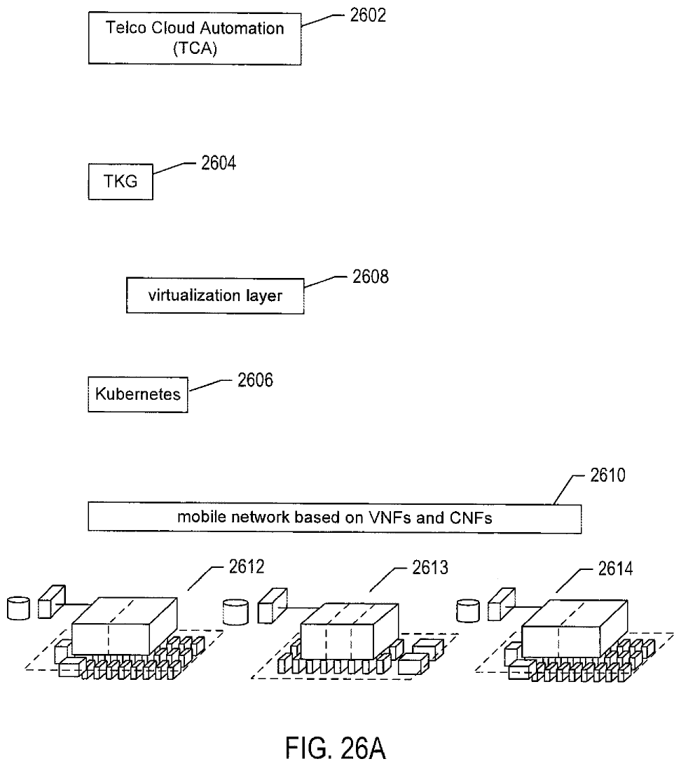

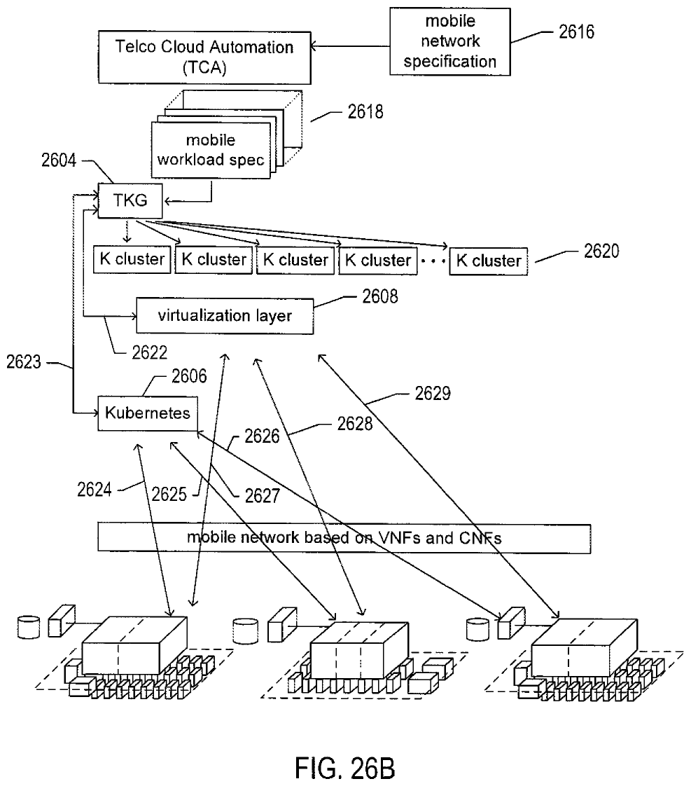

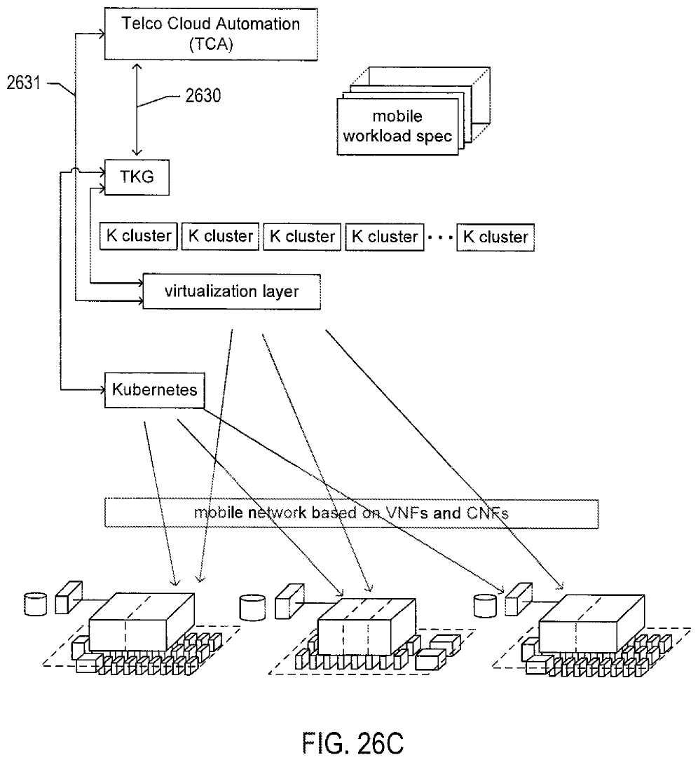

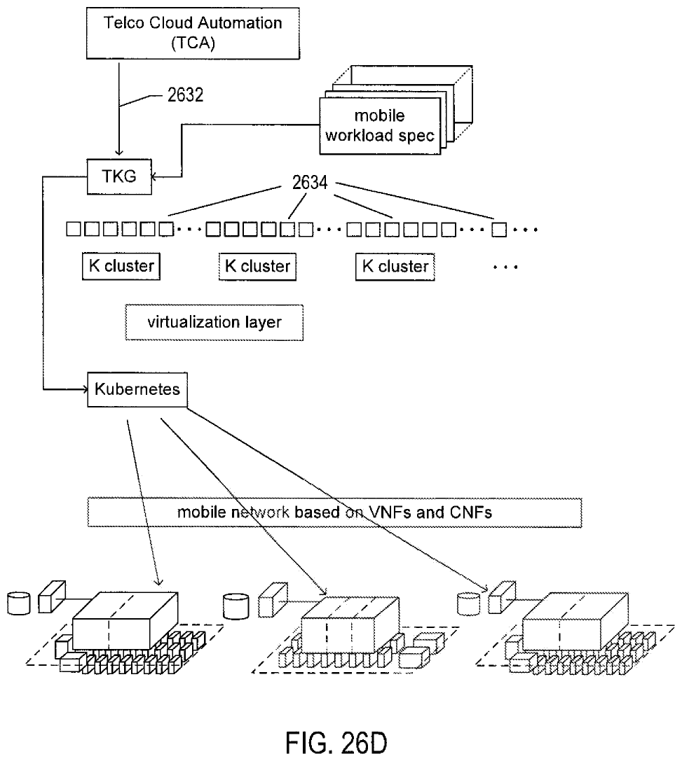

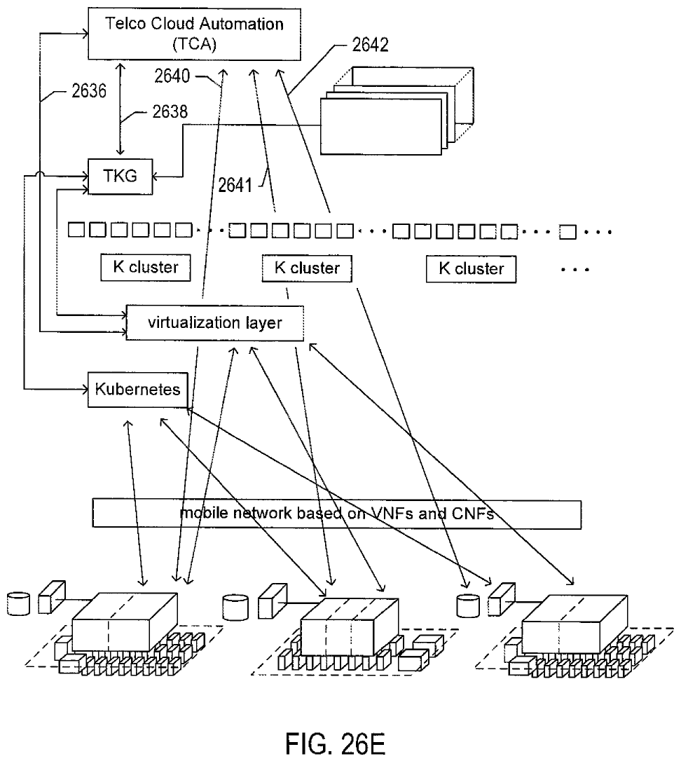

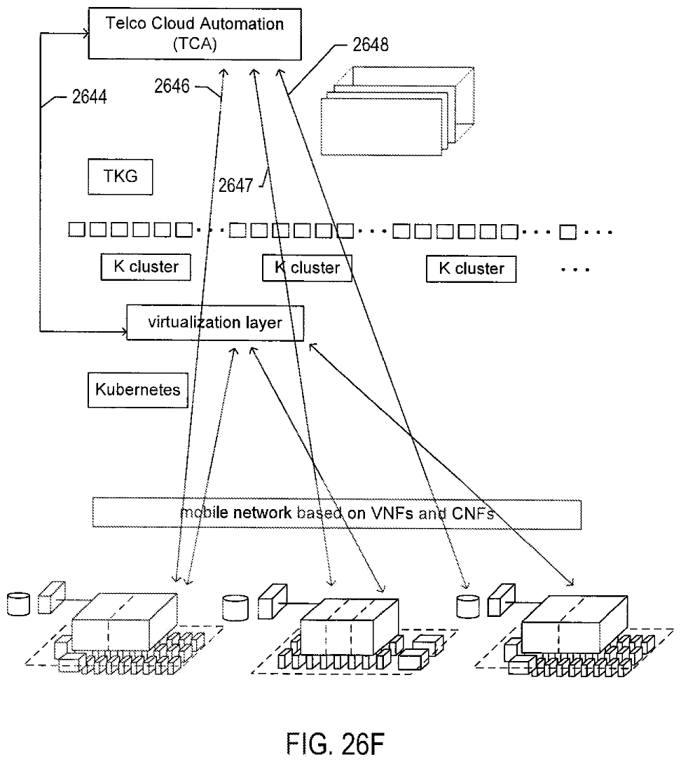

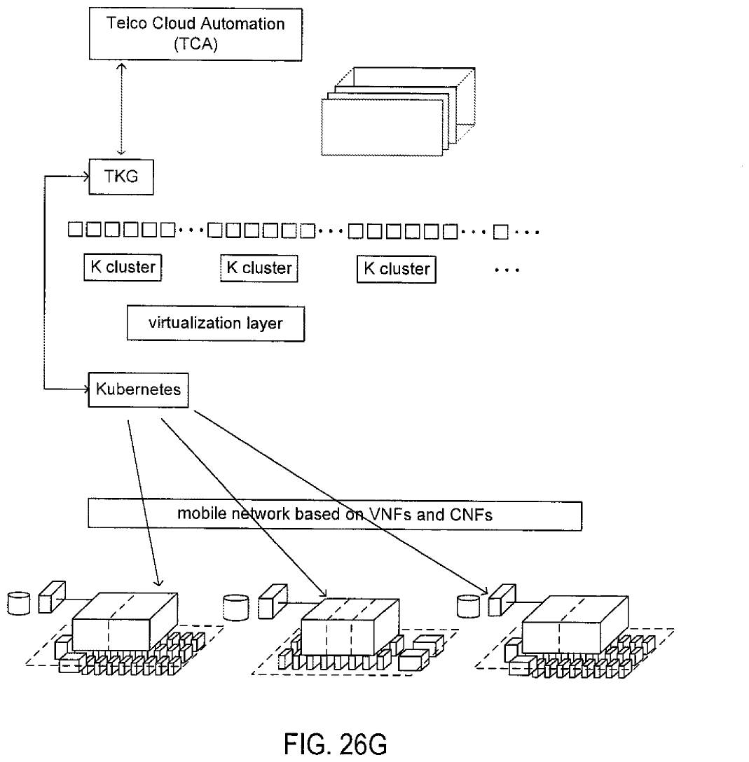

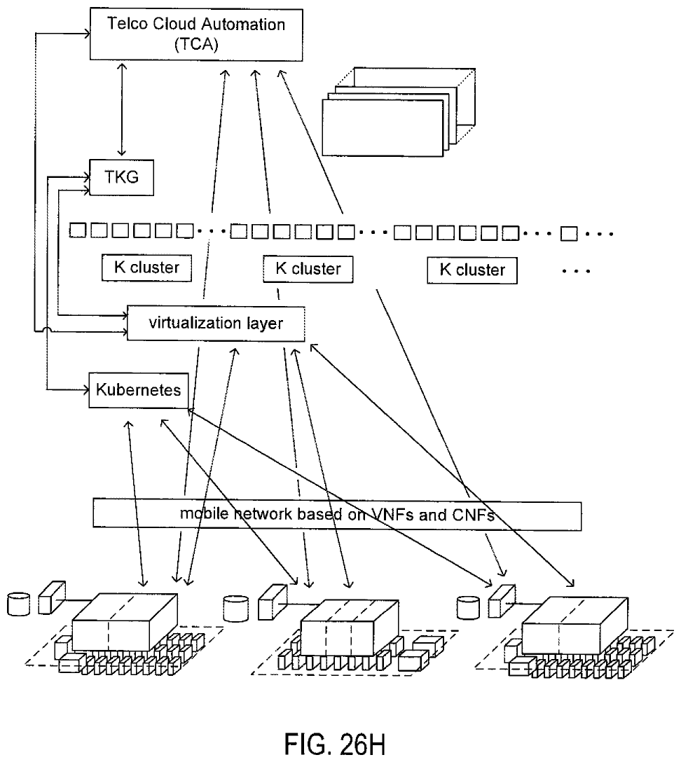

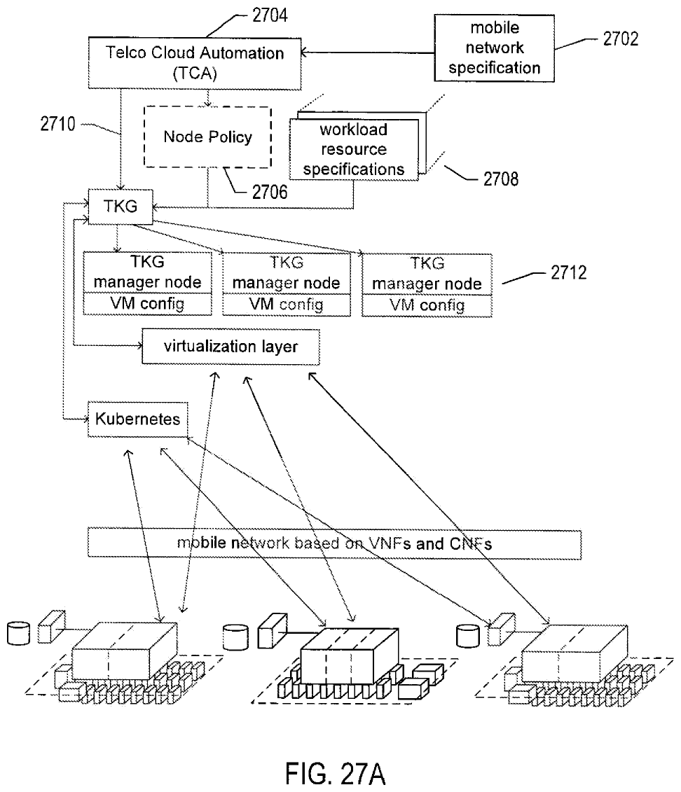

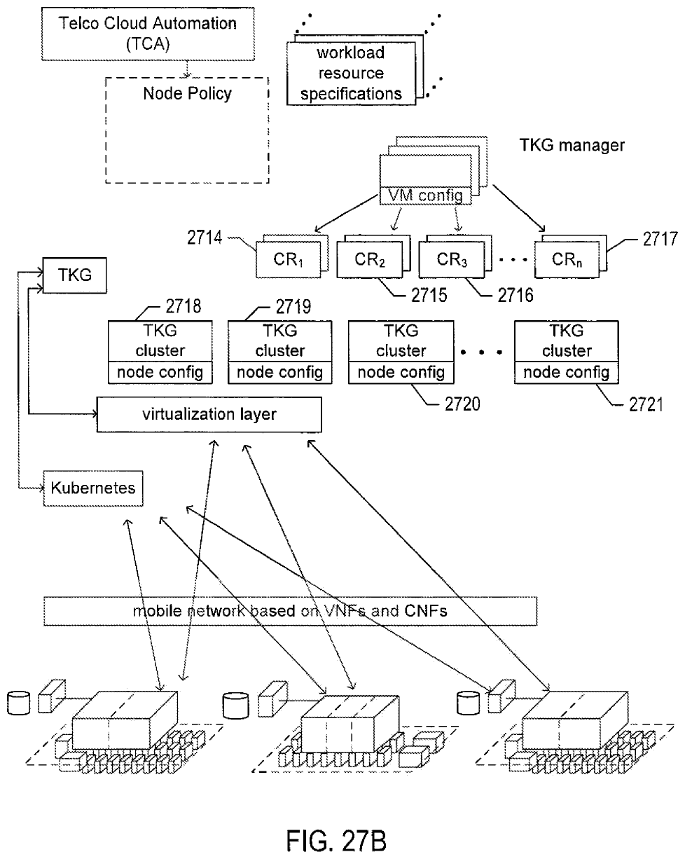

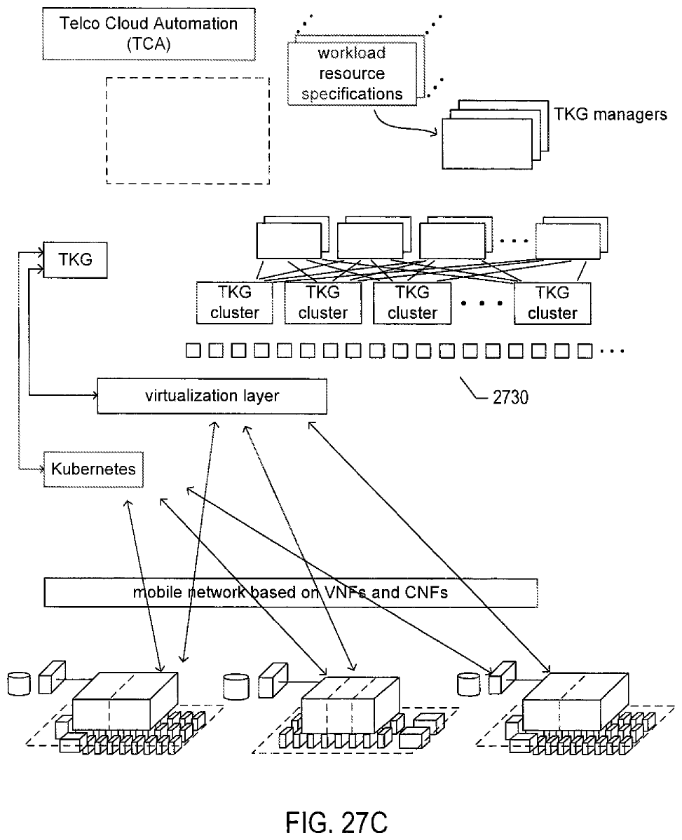

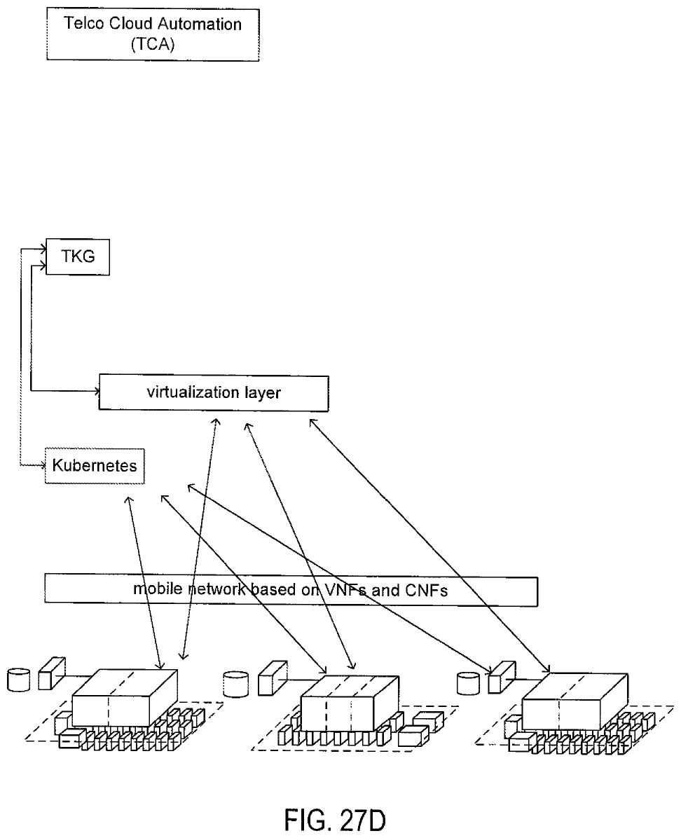

The current document is directed to methods and subsystems that that instantiate and manage mobile-network computational infrastructure. In a first subsection. below, a detailed description of computer hardware, complex computational systems, and virtualization is provided with reference to FIGS. 1-14. In a second subsection. the Kubernetes orchestration system is discussed, with reference to FIGS. 15-20. Mobile-network infrastructure is discussed in a third subsection, with reference to FIGS. 21-24. A currently available mobile-network-computational-infrastructure instantiation and management subsystem is discussed in a fourth subsection, with reference to FIGS. 25-26H. The currently disclosed methods and systems are discussed with reference to FIGS. 27A-D.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible. physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example. one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces. and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media. including multiple, high-speed serial interconnects. These busses or serial interconnections, in turn, connect the CPUs and memory with specialized processors, such as a graphics processor 118. and with one or more additional bridges 120, which are interconnected with high-speed serial links or with multiple controllers 122-127. such as controller 127, that provide access to various different types of mass-storage devices 128, electronic displays, input devices, and other such components. subcomponents. and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course. there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers. but may also include a plethora of various types of special-purpose computing devices, including data-storage systems, communications routers, network nodes, tablet computers. and mobile telephones.

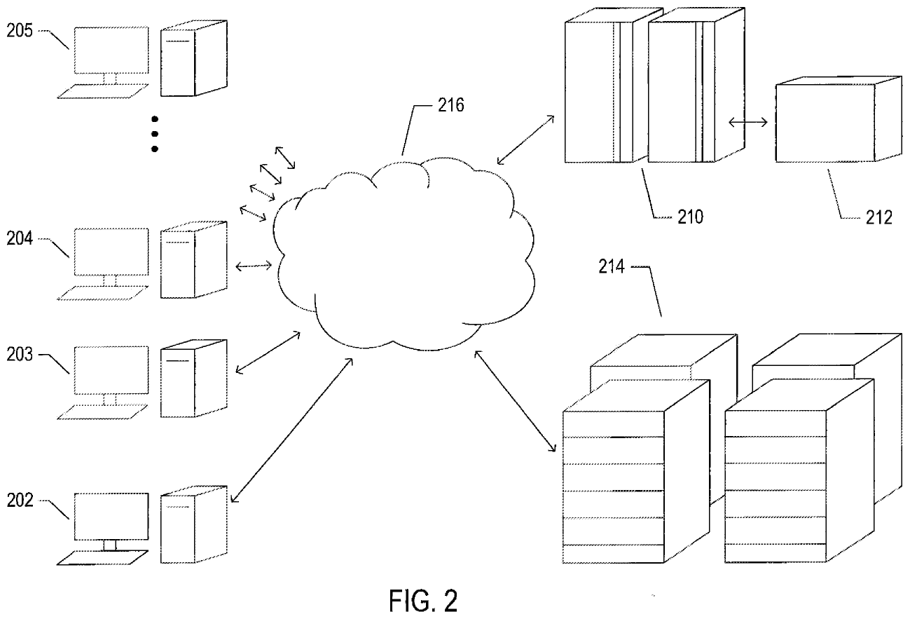

FIG. 2 illustrates an Internet-connected distributed computing system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks. wireless communications, and the Internet. FIG. 2 shows a typical distributed system in which a large number of PCs 202-205, a high-end distributed mainframe system 210 with a large data-storage system 212. and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased. configured, managed, and maintained by service-provider organizations. For example, an e-commerce retailer generally purchased, configured. managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

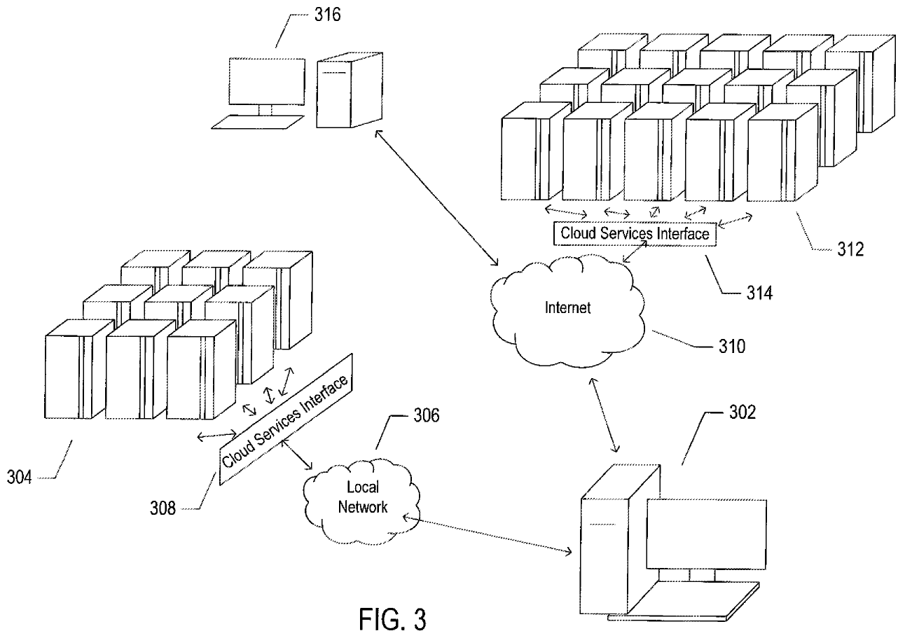

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to. or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can. in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase. manage. and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities. flexibility in the types of applications and operating systems that can be configured, and other functionalities that are useful even for owners and administrators of private cloud-computing facilities used by a single organization.

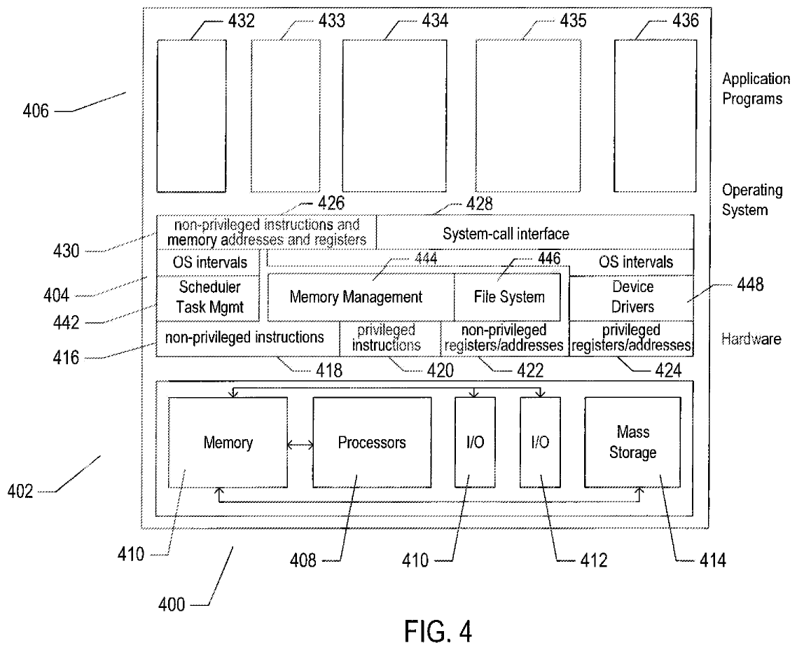

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404: and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions. privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442. memory management 444. a file system 446, device drivers 448, and many other components and modules. To a certain degree. modern operating systems provide numerous levels of abstraction above the hardware level, including virtual memory. which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint. the application program executes continuously without concern for the need to share processor resources and other system resources with other application programs and higher-level computational entities. The device drivers abstract details of hardware-component operation. allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems. the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and load-balancing purposes. The problems are even greater in heterogeneous distributed computing systems which include different types of hardware and devices running different types of operating systems. Operating systems continue to evolve, as a result of which certain older application programs and other computational entities may be incompatible with more recent versions of operating systems for which they are targeted. creating compatibility issues that are particularly difficult to manage in large distributed systems.

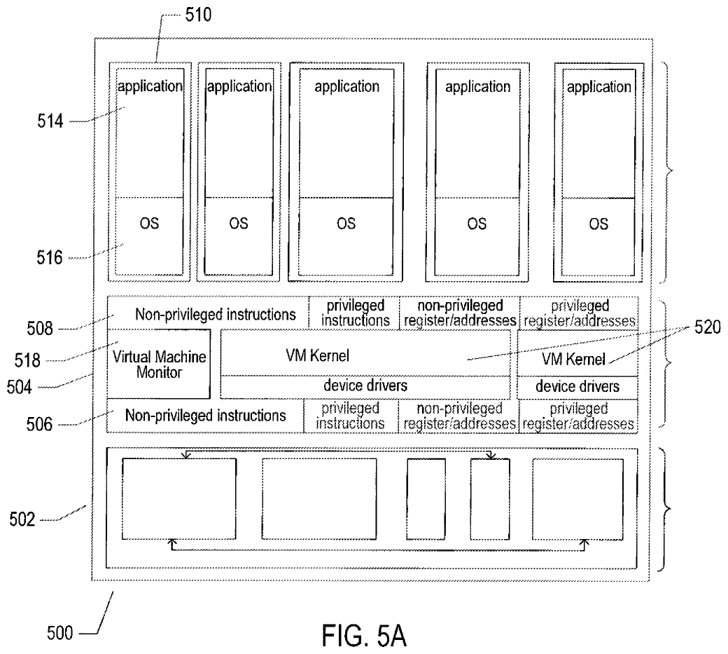

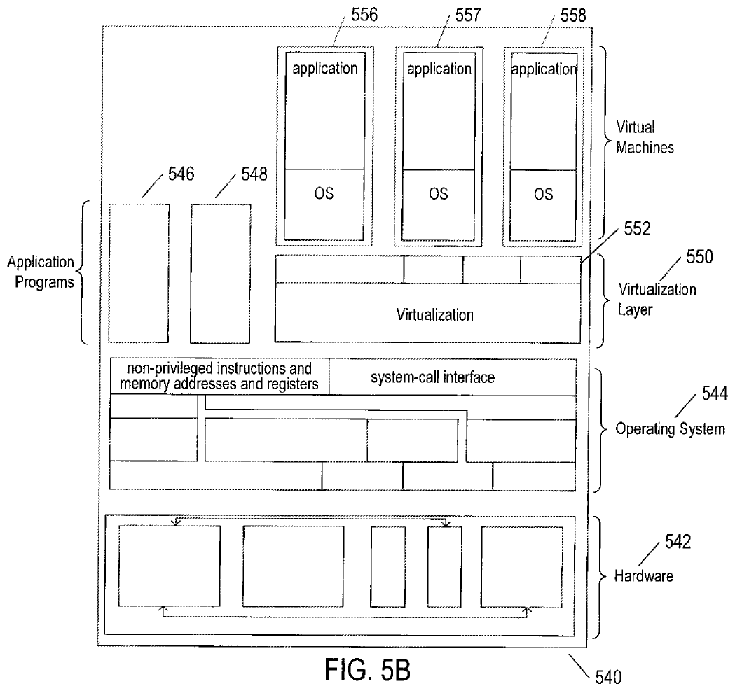

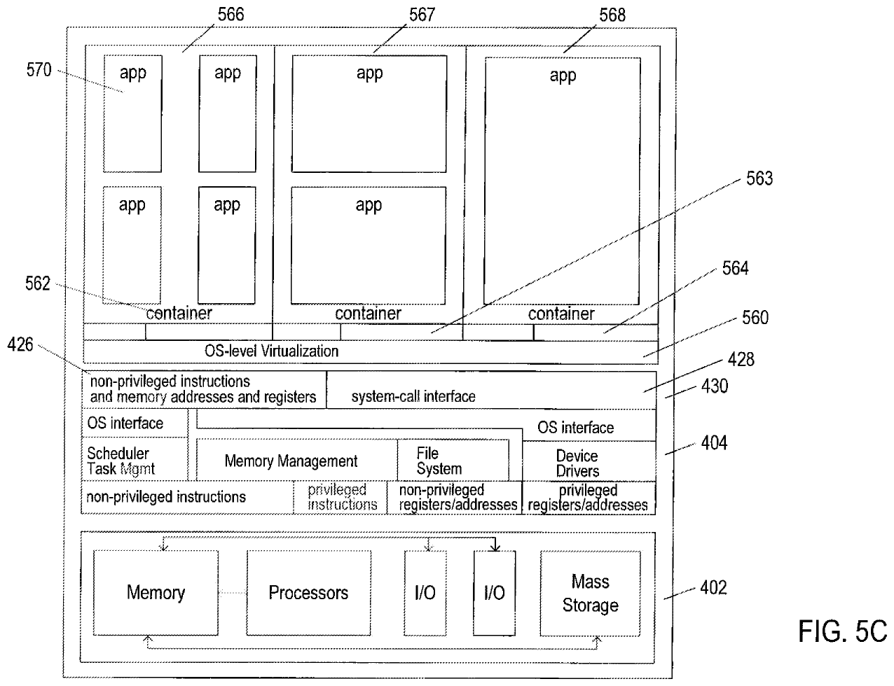

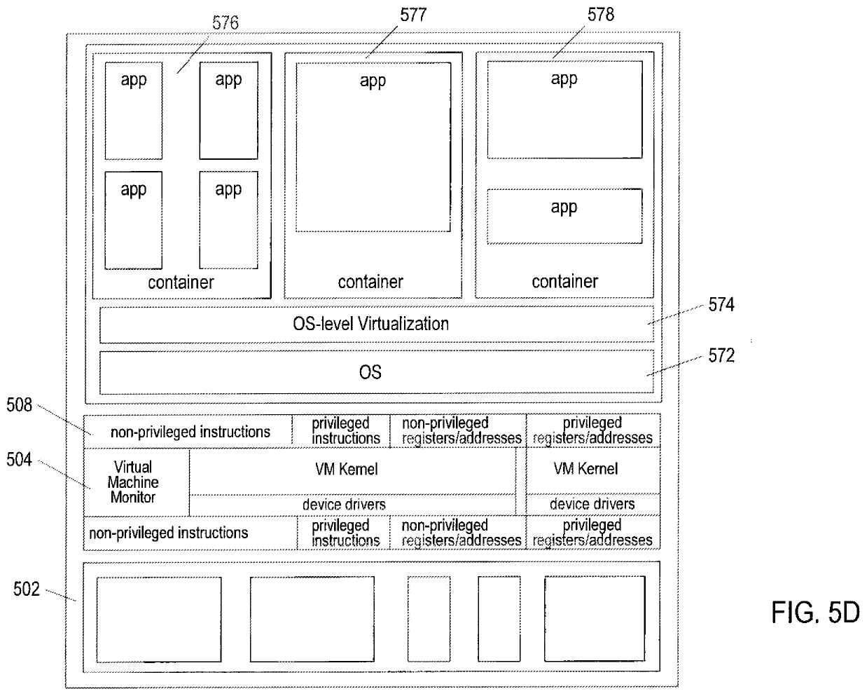

For all of these reasons. a higher level of abstraction. referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer. as in FIG. 4. the virtualized computing environment illustrated in FIG. 5A features a virtualization layer 504 that interfaces through a virtualization-layer/hardware-layer interface 506, equivalent to interface 416 in FIG. 4. to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines. in general. are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions. virtual privileged registers. and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540. but, unlike the virtualization layer 504 discussed with reference to FIG. 5A. virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558. each including one or more application programs or other higher-level computational entities packaged together with a guest operating system.

While the traditional virtual-machine-based virtualization layers, described with reference to FIGS. 5A-B. have enjoyed widespread adoption and use in a variety of different environments, from personal computers to enormous distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence. OSL virtualization uses operating-system features, such as name space support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies,

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D. provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines. each of which supports one or more containers.

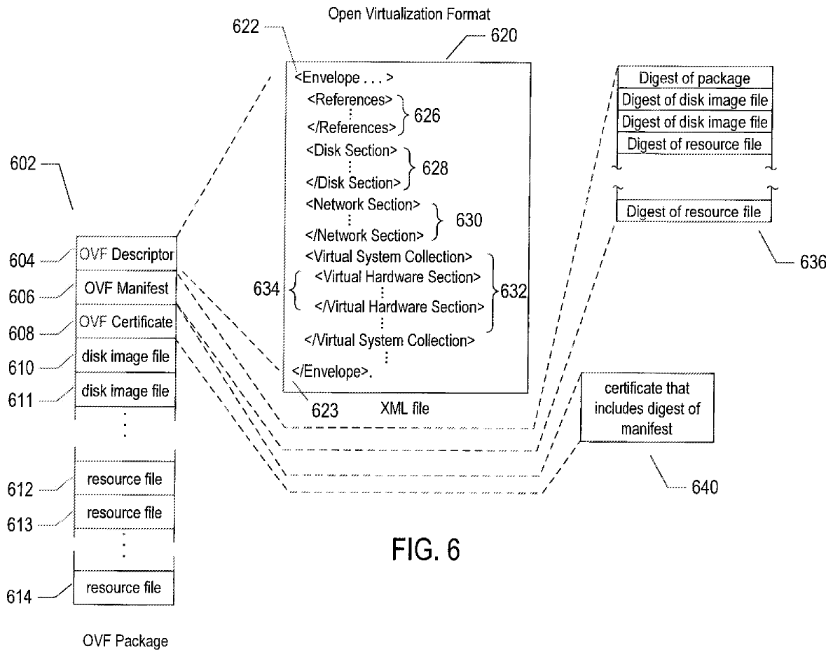

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608. one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting. distributing, and loading files. A virtual appliance is a software service that is delivered as a complete software stack installed within one or more virtual machines that is encoded within an OVF package.

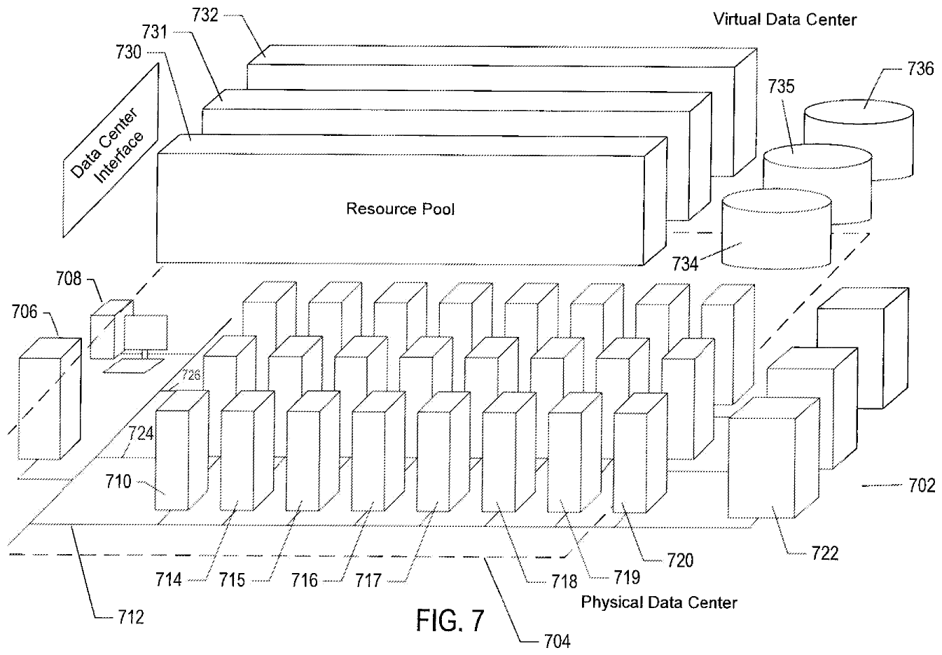

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction. referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736. and one or more virtual networks. In certain implementations, the resource pools abstract banks of physical servers directly interconnected by a local area network.

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the VI-management-server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound. data-access bound, suspends execution, or fails. Thus, the virtual data center layer of abstraction provides a virtual-data-center abstraction of physical data centers to simplify provisioning. launching. and maintenance of virtual machines and virtual appliances as well as to provide high-level, distributed functionalities that involve pooling the resources of individual physical servers and migrating virtual machines among physical servers to achieve load balancing, fault tolerance. and high availability.

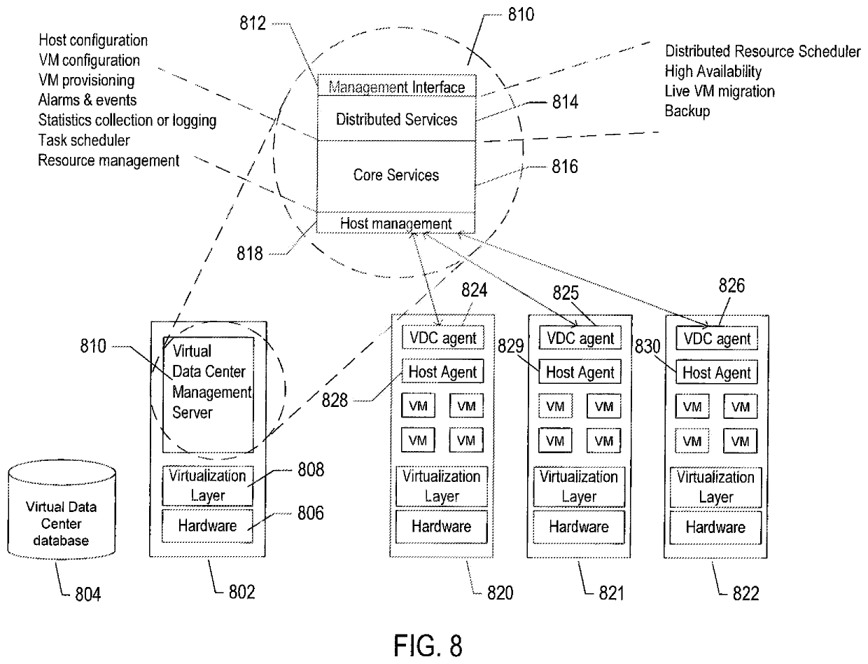

FIG. 8 illustrates virtual-machine components of a VI-management-server and physical servers of a physical data center above which a virtual-data-center interface is provided by the VI-management-server. The VI-management-server 802 and a virtual-data-center database 804 comprise the physical components of the management component of the virtual data center. The VI-management-server 802 includes a hardware layer 806 and virtualization layer 808 and runs a virtual-data-center management-server virtual machine 810 above the virtualization layer. Although shown as a single server in FIG. 8, the VI-management-server (“VI management server”) may include two or more physical server computers that support multiple VI-management-server virtual appliances. The virtual machine 810 includes a management-interface component 812, distributed services 814, core services 816, and a host-management interface 818, The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VI management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VI management server include host configuration, virtual-machine configuration. virtual-machine provisioning, generation of virtual-data-center alarms and events, ongoing event logging and statistics collection, a task scheduler. and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-datacenter agents are primarily responsible for offloading certain of the virtual-data-center management-server functions specific to a particular physical server to that physical server. The virtual-data-center agents relay and enforce resource allocations made by the VI management server, relay virtual-machine provisioning and configuration-change commands to host agents. monitor and collect performance statistics, alarms, and events communicated to the virtual-data-center agents by the local host agents through the interface API, and to carry out other. similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition. the cloud director introduces a multi-tenancy layer of abstraction, which partitions virtual data centers (“VDCs”) into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

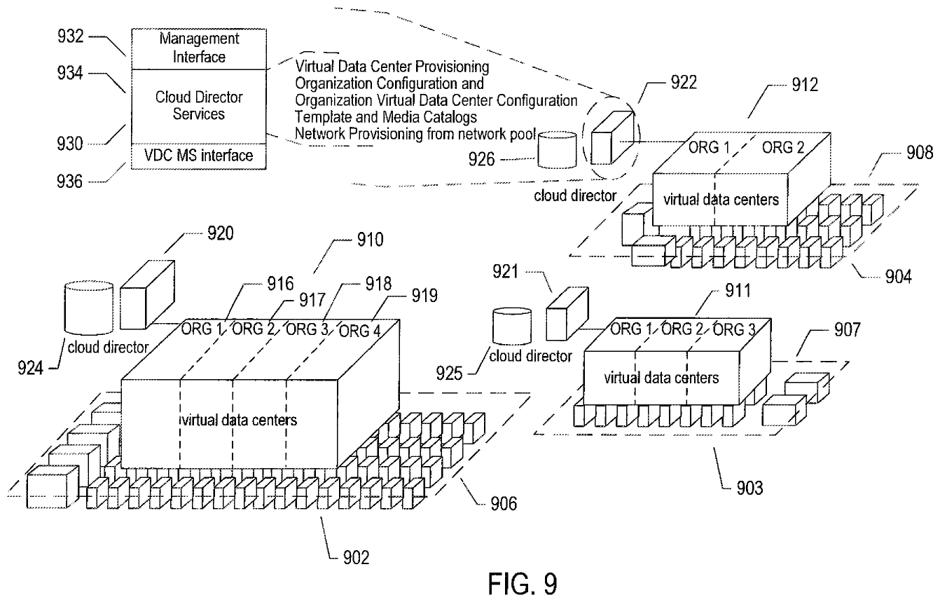

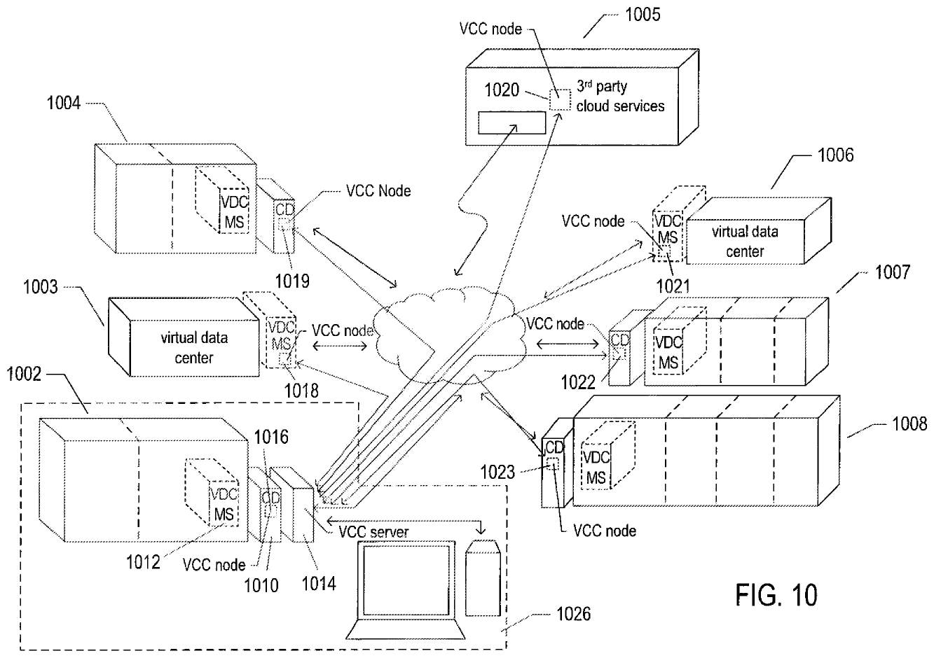

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants. tools and interfaces for configuring and managing tenant organizations, tools and services for organization of virtual data centers and tenant-associated virtual data centers within the multi-tenant virtual data center, services associated with template and media catalogs. and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VI management server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

FIG. 10 illustrates virtual-cloud-connector nodes (“VCC nodes”) and a VCC server. components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are illustrated 1002-1008. Cloud-computing facility 1002 is a private multi-tenant cloud with a cloud director 1010 that interfaces to a VI management server 1012 to provide a multi-tenant private cloud comprising multiple tenant-associated virtual data centers. The remaining cloud-computing facilities 1003-1008 may be either public or private cloud-computing facilities and may be single-tenant virtual data centers. such as virtual data centers 1003 and 1006, multi-tenant virtual data centers, such as multi-tenant virtual data centers 1004 and 1007-1008. or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VI management server that manages a single-tenant private cloud. The VCC server 1014 additionally interfaces, through the Internet, to VCC node virtual appliances executing within remote VI management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general. the cloud-computing facilities that together form a multiple-cloud-computing aggregation through distributed services provided by the WC server and VCC nodes are geographically and operationally distinct.

The current document discusses migration of a virtual-network subsystem within a virtual distributed computer system from a first version and/or implementation to a second version and/or implementation as an example of migration of a virtual subsystem within a distributed computer system to which implementations of the currently disclosed methods and systems can be applied. However, the currently disclosed methods and systems can be generally applied to the migration of various different types of virtual subsystems, in addition to virtual-network subsystems.

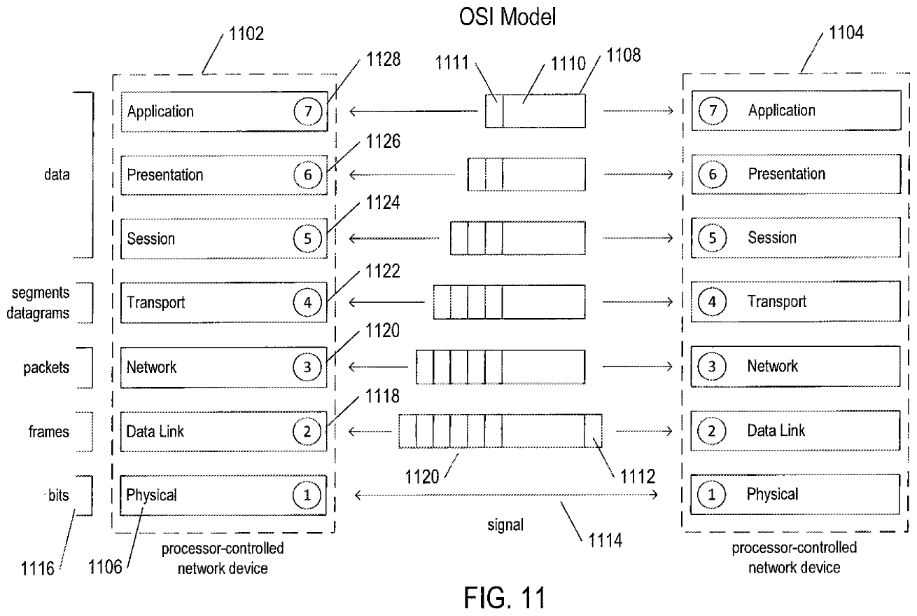

FIG. 11 illustrates the Open Systems Interconnection model (“OSI model”) that characterizes many modern approaches to implementation of communications systems that interconnect computers. In FIG. 11, two processor-controlled network devices, or computer systems, are represented by dashed rectangles 1102 and 1104. Within each processor-controlled network device, a set of communications layers are shown, with the communications layers both labeled and numbered. For example, the first communications level 1106 in network device 1102 represents the physical layer which is alternatively designated as layer 1. The communications messages that are passed from one network device to another at each layer are represented by divided rectangles in the central portion of FIG. 11. such as divided rectangle 1108. The largest rectangular division 1110 in each divided rectangle represents the data contents of the message. Smaller rectangles. such as rectangle 1111. represent message headers that are prepended to a message by the communications subsystem in order to facilitate routing of the message and interpretation of the data contained in the message, often within the context of an interchange of multiple messages between the network devices. Smaller rectangle 1112 represents a footer appended to a message to facilitate data-link-layer frame exchange. As can be seen by the progression of messages down the stack of corresponding communications-system layers, each communications layer in the OSI model generally adds a header or a header and footer specific to the communications layer to the message that is exchanged between the network devices.

It should be noted that while the OSI model is a useful conceptual description of the modern approach to electronic communications, particular communications-systems implementations may depart significantly from the seven-layer OSI model. However, in general. the majority of communications systems include at least subsets of the functionality described by the OSI model. even when that functionality is alternatively organized and layered.

The physical layer. or layer 1. represents the physical transmission medium and communications hardware. At this layer. signals 1114 are passed between the hardware communications systems of the two network devices 1102 and 1104. The signals may be electrical signals, optical signals. or any other type of physically detectable and transmittable signal. The physical layer defines how the signals are interpreted to generate a sequence of bits 1116 from the signals. The second data-link layer 1118 is concerned with data transfer between two nodes, such as the two network devices 1102 and 1104. At this layer, the unit of information exchange is referred to as a “data frame” 1120. The data-link layer is concerned with access to the communications medium, synchronization of data-frame transmission, and checking for and controlling transmission errors. The third network layer 1120 of the OSI model is concerned with transmission of variable-length data sequences between nodes of a network. This layer is concerned with networking addressing, certain types of routing of messages within a network. and disassembly of a large amount of data into separate frames that are reassembled on the receiving side. The fourth transport layer 1122 of the OSI model is concerned with the transfer of variable-length data sequences from a source node to a destination node through one or more networks while maintaining various specified thresholds of service quality. This may include retransmission of packets that fail to reach their destination, acknowledgement messages and guaranteed delivery, error detection and correction, and many other types of reliability. The transport layer also provides for node-to-node connections to support multi-packet and multi-message conversations, which include notions of message sequencing. Thus. layer 4 can be considered to be a connections-oriented layer. The fifth session layer of the OSI model 1124 involves establishment. management, and termination of connections between application programs running within network devices. The sixth presentation layer 1126 is concerned with communications context between application-layer entities, translation and mapping of data between application-layer entities, data-representation independence, and other such higher-level communications services. The final seventh application layer 1128 represents direct interaction of the communications systems with application programs. This layer involves authentication, synchronization, determination of resource availability, and many other services that allow particular applications to communicate with one another on different network devices. The seventh layer can thus be considered to be an application-oriented layer.

In the widely used TCP/IP communications protocol stack. the seven OSI layers are generally viewed as being compressed into a data-frame layer, which includes OSI layers 1 and 2, a transport layer, corresponding to OSI layer 4, and an application layer, corresponding to OSI layers 5-7. These layers are commonly referred to as “layer 2,” “layer 4,” and “layer 7.” to be consistent with the OSI terminology.

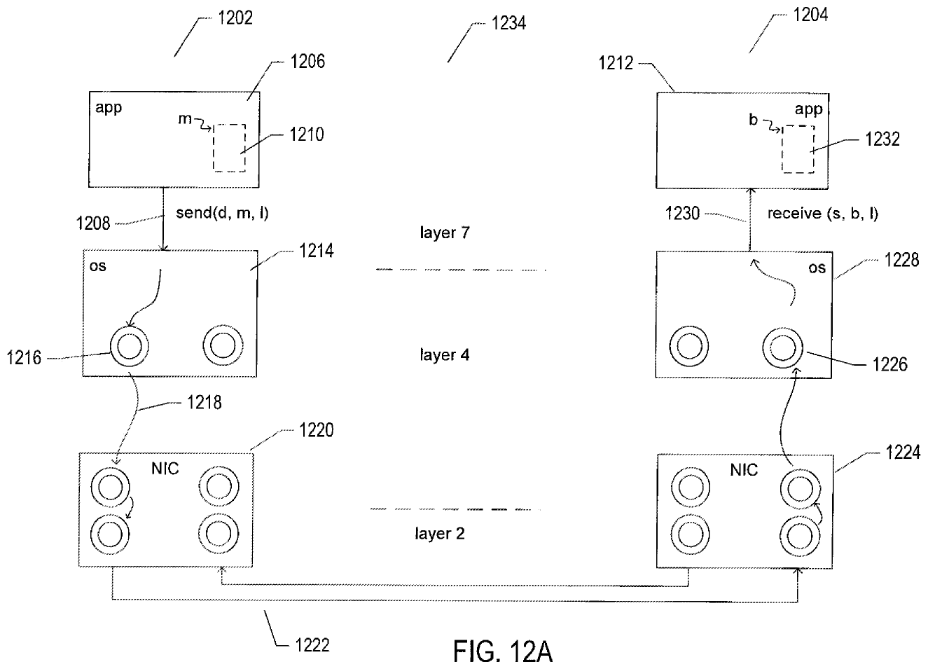

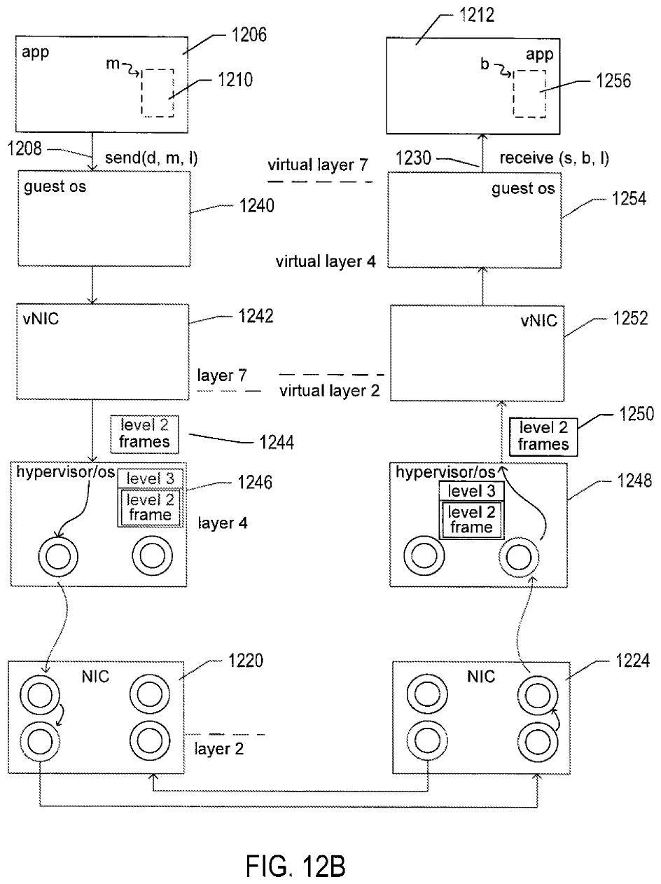

FIGS. 12A-B illustrate a layer-2-over-layer-3 encapsulation technology on which virtualized networking can be based. FIG. 12A shows a traditional network communications between two applications running on two different computer systems. Representations of components of the first computer system are shown in a first column 1202 and representations of components of the second computer system shown in a second column 1204. An application 1206 running on the first computer system calls an operating-system function, represented by arrow 1208, to send a message 1210 stored in application-accessible memory to an application 1212 running on the second computer system. The operating system on the first computer system 1214 moves the message to an output-message queue 1216 from which it is transferred 1218 to a network-interface-card (“NIC”) 1220, which decomposes the message into frames that are transmitted over a physical communications medium 1222 to a NIC 1224 in the second computer system. The received frames are then placed into an incoming-message queue 1226 managed by the operating system 1228 on the second computer system, which then transfers 1230 the message to an application-accessible memory 1232 for reception by the second application 1212 running on the second computer system. In general, communications are bidirectional. so that the second application can similarly transmit messages to the first application. In addition, the networking protocols generally return acknowledgment messages in response to reception of messages. As indicated in the central portion of FIG. 12A 1234. the NIC-to-NIC transmission of data frames over the physical communications medium corresponds to layer-2 (“L2”) network operations and functionality, layer-4 (“L4”) network operations and functionality are carried out by a combination of operating-system and NIC functionalities, and the system-call-based initiation of a message transmission by the application program and operating system represents layer-7 (“L7”) network operations and functionalities. The actual precise boundary locations between the layers may vary depending on particular implementations.

FIG. 12B shows use of a layer-2-over-layer-3 encapsulation technology in a virtualized network communications scheme. FIG. 12B uses similar illustration conventions as used in FIG. 12A. The first application 1206 again employs an operating-system call 1208 to send a message 1210 stored in local memory accessible to the first application. However, the system call, in this case. is received by a guest operating system 1240 running within a virtual machine. The guest operating system queues the message for transmission to a virtual NIC 1242 (“vNIC”), which transmits L2 data frames 1244 to a virtual communications medium. What this means. in the described implementation, is that the L2 data frames are received by a hypervisor 1246. which packages the L2 data frames into L3 data packets and then either directly, or via an operating system, provides the L3 data packets to a physical NIC 1220 for transmission to a receiving physical NIC 1224 via a physical communications medium. In other words, the L2 data frames produced by the virtual NIC are encapsulated in higher-level-protocol packets or messages that are then transmitted through a normal communications protocol stack and associated devices and components. The receiving physical NIC reconstructs the L3 data packets and provides them to a hypervisor and/or operating system 1248 on the receiving computer system, which unpackages the L2 data frames 1250 and provides the L2 data frames to a vNIC 1252. The vNIC, in turn. reconstructs a message or messages from the L2 data frames and provides a message to a guest operating system 1254, which reconstructs the original application-layer message 1256 in application-accessible memory. Of course, the same process can be used by the application 1212 on the second computer system to send messages to the application 1206 and the first computer system.

The layer-2-over-layer-3 encapsulation technology provides a basis for generating complex virtual networks and associated virtual-network elements, such as firewalls, routers, edge routers, and other virtual-network elements within a virtual data centers, discussed above, with reference to FIGS. 7-10, in the context of a preceding discussion of virtualization technologies that references FIGS. 4-6. Virtual machines and vNICs are implemented by a virtualization layer. and the layer-2-over-layer-3 encapsulation technology allows the L2 data frames generated by a vNIC implemented by the virtualization layer to be physically transmitted, over physical communications facilities, in higher-level protocol messages or. in some cases. over internal buses within a server, providing a relatively simple interface between virtualized networks and physical communications networks.

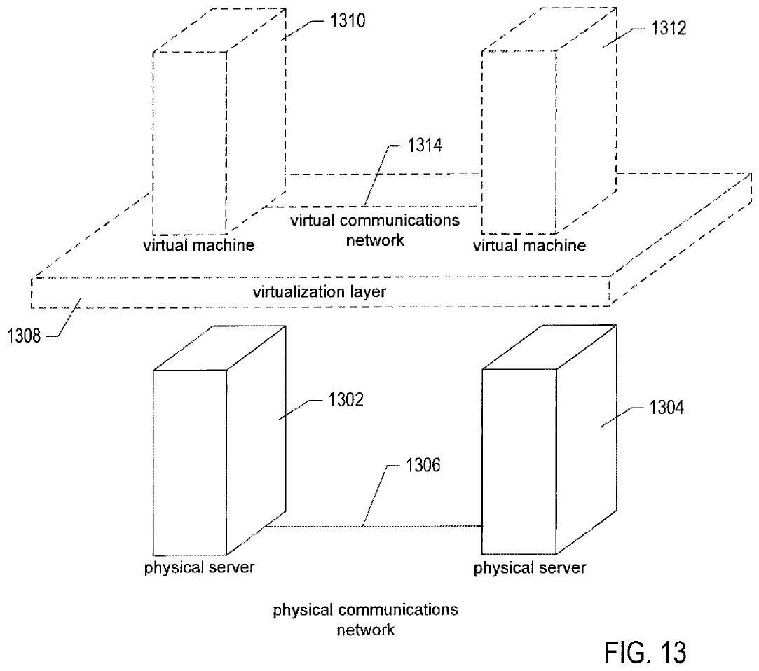

FIG. 13 illustrates virtualization of two communicating servers. A first physical server 1302 and a second physical server 1304 are interconnected by physical communications network 1306 in the lower portion of FIG. 13. Virtualization layers running on both physical servers together compose a distributed virtualization layer 1308, which can then implement a first virtual machine (“VM”) 1310 and a second VM 1312 that are interconnected by a virtual communications network 1314. The first VM and the second VM may both execute on the first physical server, may both execute on the second physical server, or one VM may execute on one of the two physical servers and the other VM may execute on another of the two physical servers. The VMs may move from one physical server to another while executing applications and guest operating systems. The characteristics of the VMs, including computational bandwidths. memory capacities, instruction sets. and other characteristics. may differ from the characteristics of the underlying servers. Similarly, the characteristics of the virtual communications network 1314 may differ from the characteristics of the physical communications network 1306. As one example, the virtual communications network 1314 may provide for interconnection of 10, 20, or more virtual machines, and may include multiple local virtual networks bridged by virtual switches or virtual routers, while the physical communications network 1306 may be a local area network (“LAN”) or point-to-point data exchange medium that connects only the two physical servers to one another. In essence, the virtualization layer 1308 can construct any number of different virtual machines and virtual communications networks based on the underlying physical servers and physical communications network. Of course, the virtual machines' operational capabilities, such as computational bandwidths, are constrained by the aggregate operational capabilities of the two physical servers and the virtual networks' operational capabilities are constrained by the aggregate operational capabilities of the underlying physical communications network, but the virtualization layer can partition the operational capabilities in many different ways among many different virtual entities, including virtual machines and virtual networks.

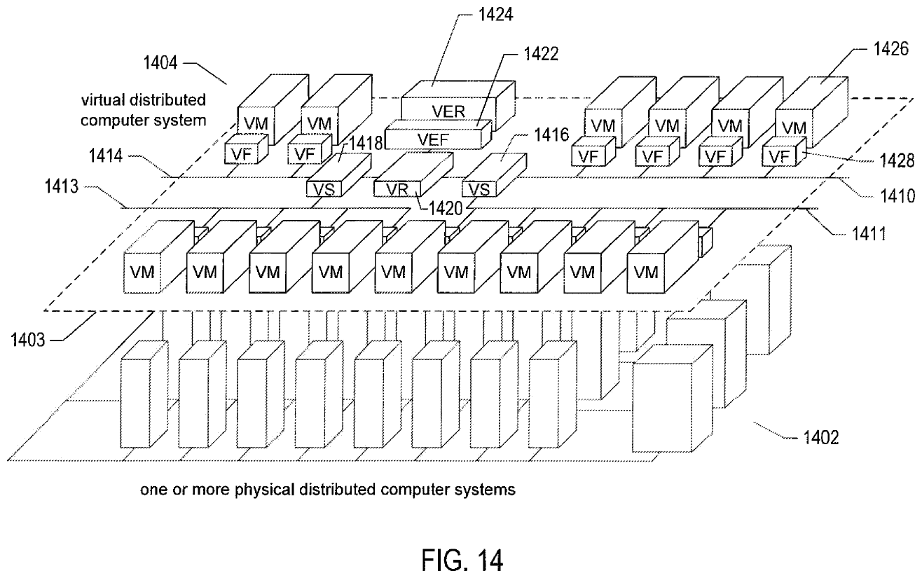

FIG. 14 illustrates a virtual distributed computer system based on one or more distributed computer systems. The one or more physical distributed computer systems 1402 underlying the virtual/physical boundary 1403 are abstracted, by virtualization layers running within the physical servers, as a virtual distributed computer system 1404 shown above the virtual physical boundary. In the virtual distributed computer system 1404, there are numerous virtual local area networks (“LANs”) 1410-1414 interconnected by virtual switches (“vSs”) 1416 and 1418 to one another and to a virtual router (“vR”) 1421 that interconnects the virtual router through a virtual edge-router firewall (“vEF”) 1422 to a virtual edge router (“vER”) 1424 that, in turn, interconnects the virtual distributed computer system with external data centers, external computers, and other external network-communications-enable devices and systems. A large number of virtual machines, such as virtual machine 1426, are connected to the LANs through virtual firewalls (“vFs”). such as vF 1428. The VMs, vFs, vSs, vR, vEF, and vER are implemented largely by execution of stored computer instructions by the hypervisors within the physical servers, and while underlying physical resources of the one or more physical distributed computer systems are employed to implement the virtual distributed computer system, the components, topology, and organization of the virtual distributed computer system is largely independent from the underlying one or more physical distributed computer systems.

Virtualization provides many important and significant advantages, Virtualized distributed computer systems can be configured and launched in time frames ranging from seconds to minutes, while physical distributed computer systems often require weeks or months for construction and configuration. Virtual machines can emulate many different types of physical computer systems with many different types of physical computer-system architectures, so that a virtual distributed computer system can run many different operating systems, as guest operating systems, that would otherwise not be compatible with the physical servers of the underlying one or more physical distributed computer systems. Similarly. virtual networks can provide capabilities that are not available in the underlying physical networks. As one example, the virtualized distributed computer system can provide firewall security to each virtual machine using vFs. as shown in FIG. 14. This allows a much finer granularity of network-communications security, referred to as “microsegmentation,” than can be provided by the underlying physical networks. Additionally, virtual networks allow for partitioning of the physical resources of an underlying physical distributed computer system into multiple virtual distributed computer systems, each owned and managed by different organizations and individuals, that are each provided full security through completely separate internal virtual LANs connected to virtual edge routers. Virtualization thus provides capabilities and facilities that are unavailable in non-virtualized distributed computer systems and that provide enormous improvements in the computational services that can be obtained from a distributed computer system.

### Kubernetes

Kubernetes is an open-source containerized-application orchestration system that provides an abstraction layer above virtual and physical computational resources within a data center or cloud-computing facility. Containers are a type of virtualized application-execution environment discussed above with reference to FIGS. 5C-D. Containerized applications are applications that packaged for execution within containers. Kubernetes automatically distributes and schedules containerized applications across physical and virtual computational resources of a data center or cloud-computing facility. As one example, modern service-oriented applications are generally implemented by distributed applications running on the multiple virtual machines or containers within multiple physical servers of a data center or cloud-computing facility. Rather than manually installing and managing all of these different virtual machines and/or containers, a user can develop Kubernetes workload-resource specifications and supply the workload-resource specifications along with references to containerized applications to a Kubernetes orchestration system, which instantiates and manages operation of the service-oriented application.

FIG. 15 illustrates a fundamental Kubernetes abstraction. A data center, cloud-computing facility, or other distributed computer system is represented, in FIG. 15, as a large number of physical computational resources, such as servers 1502. Kubernetes abstracts a portion of the physical and virtual computational resources provided by the underlying data center, cloud-computing facility, or other distributed computer system as a set of Kubernetes nodes 1504, where horizontal plane 1506 represents the fundamental Kubernetes abstraction of the underlying physical and virtual computational resources of the data center or cloud-computing facility. Kubernetes nodes may be virtual machines. physical computers, or other such computational entities that provide execution environments for containerized applications. The Kubernetes orchestration system is responsible for mapping Kubernetes nodes to the physical and virtual computational resources, including physical and virtual data-storage facilities and communications networks in addition to containerized-application execution environments.

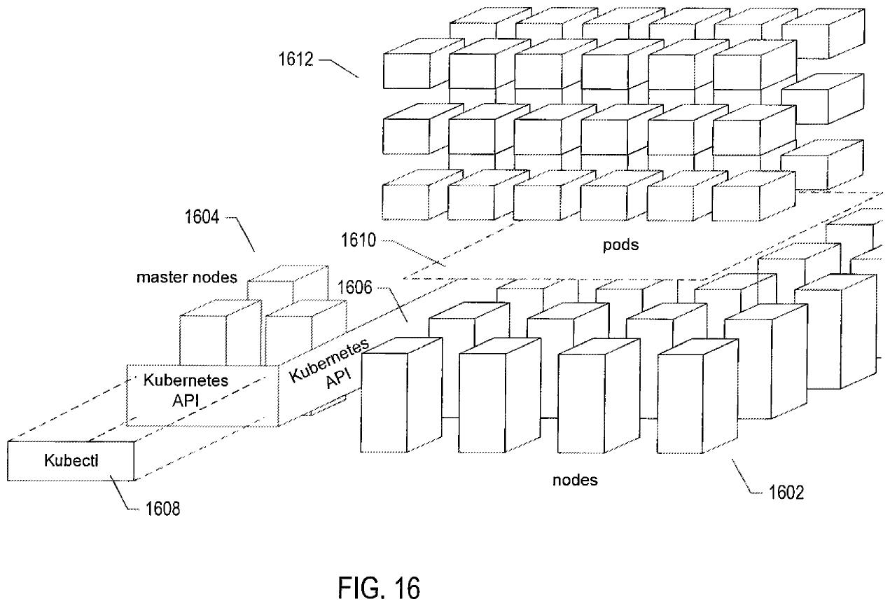

FIG. 16 illustrates a next level of abstraction provided by Kubernetes, referred to as a “Kubernetes cluster.” A Kubernetes cluster comprises a set of highly available, interconnected Kubernetes nodes that are managed by Kubernetes as a computational entity. The nodes in a cluster are partitioned into worker nodes 1602, often simply referred to as “nodes,” and master nodes 1604 that together implement a Kubernetes-cluster control plane. In general, only one of the masters nodes is active at any given time, with the inactive master nodes providing for immediate failover in the case that the active master node fails. The control plane is responsible for distributing containerized applications among the worker nodes and scheduling execution of the containerized applications. In addition, the control plane manages operation of the nodes and containerized applications executing within the nodes. The control plane provides a Kubernetes application programming interface (“API”) 1606 through which the control plane communicates with the nodes and through which Kubernetes services and facilities are accessed by users, often via the Kubectl command line interface 1608. An additional Kubernetes layer of abstraction 1610 provides a set of pods 1612 that are deployed to. and that provide execution environments within, the nodes 1602. A pod is the smallest computational unit in Kubernetes. A pod supports execution of a single container or two or more tightly coupled containers. including shared data-storage and networking resources. that are scheduled and deployed together by the cluster control plane. In many cases, a pod includes only a single container that provides an execution environment for a single instance of a containerized application. Pods are created and managed by controllers for workload resources, discussed below, and are each associated with a pod template. or pod specification.

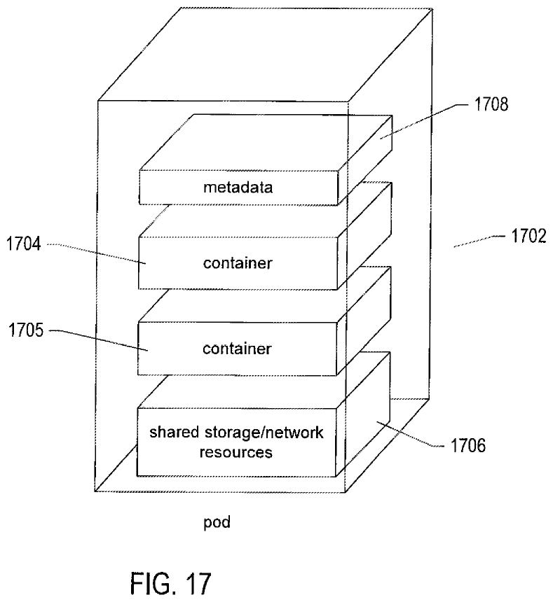

FIG. 17 illustrates the logical contents of a pod. The pod 1702 includes one or more containers 1704-1705. shared storage and networking resources 1706, and various types of metadata 1708, including operational parameters and resource requirements. A pod is assigned a set of unique network addresses that is shared, along with a set of ports. by all of the containers in the pod. Containers within a pod can communicate with one another via shared memory, semaphores, and localhost.

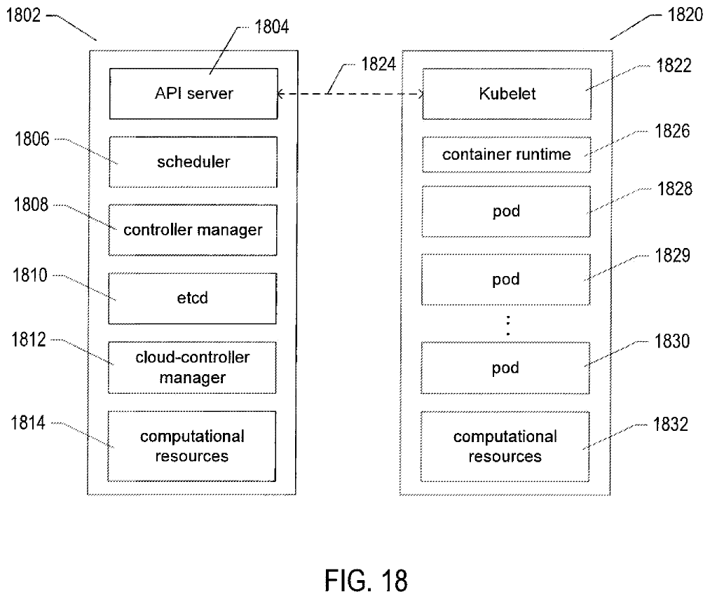

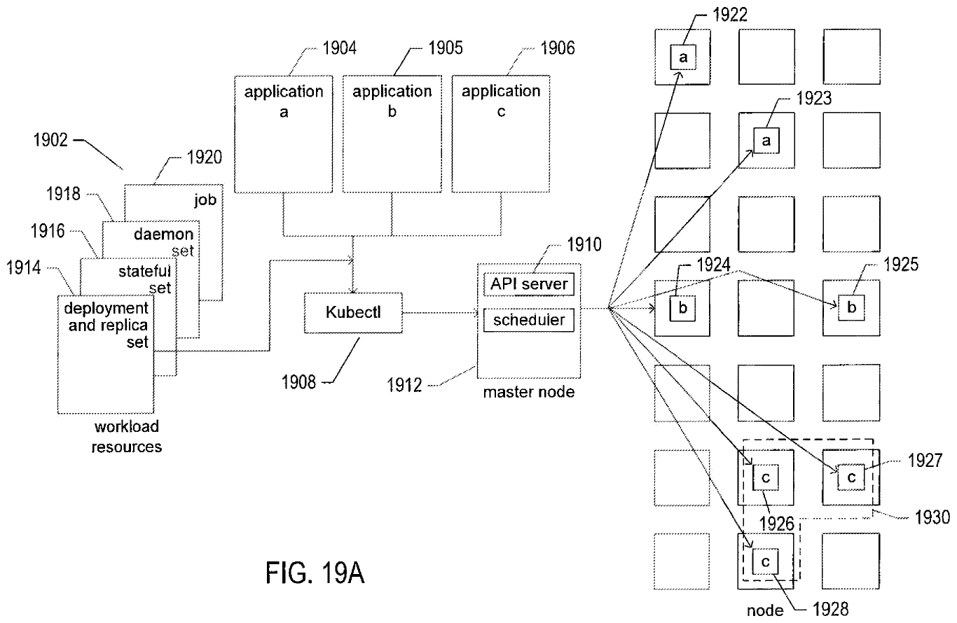

FIG. 18 illustrates the logical contents of a Kubernetes management node and a Kubernetes worker node. A Kubernetes management node 1802 includes an API server 1804 that exposes the Kubernetes API to remote entities and that implements the control-plane front-end. in addition, a Kubernetes management node includes a scheduler 1806 that is responsible for distributing newly created pods among worker nodes. matching pod requirements, constraints, affinities and parameters to the parameters and characteristics of the worker nodes to which a pod is distributed. A Kubernetes management node additionally includes a controller manager 1808 comprising multiple processes that implement multiple controllers, including a node controller, a replication controller, an endpoints controller, and a service-account-and-token controller. Controllers monitor the operational status of pods within the cluster and attempt to ameliorate any detected departures from the specified operational behaviors of the pods. For example, the node controller detects failed nodes and attempt to mitigate node failures. As another example, the replication controller monitors replication objects to ensure that the proper number of pods are running for each replication object. A Kubernetes management node further includes an etcd key-value data store 1810 and a cloud-controller manager 1812, which includes multiple controllers that manage cloud-hosted Kubernetes cluster components. The above-discussed logical components of a master node are implemented above the computational resources 1814 provided by a virtual machine or physical server. A worker node 1820 includes a Kubelet agent 1822 that manages pods running within the worker node in cooperation with the control plate, with which the Kubelet agent communicates via the Kubernetes API. as indicated by dashed arrow 1824. In addition, a worker node includes a container run time 1826, such as the Docker container runtime, and one or more pods 1828-1830 that execute using the computational resources 1832 provided by a virtual machine or physical server.

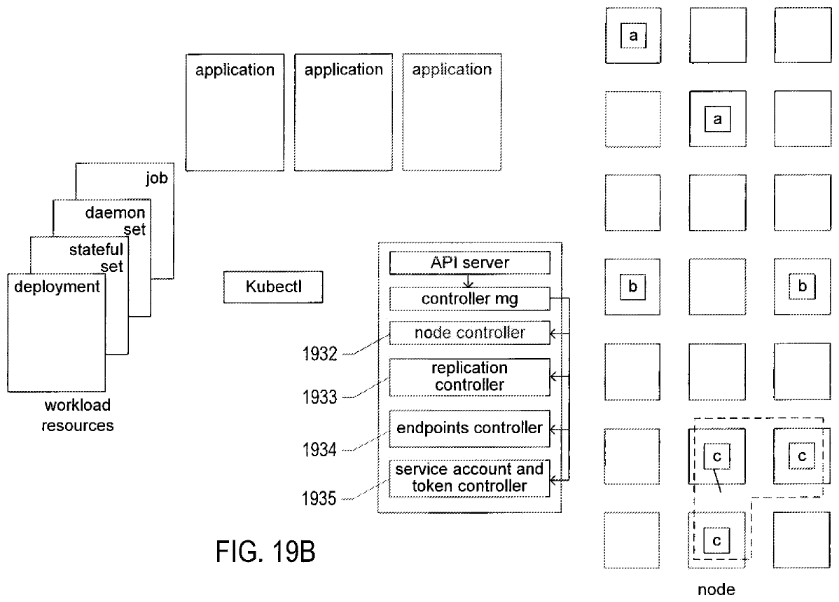

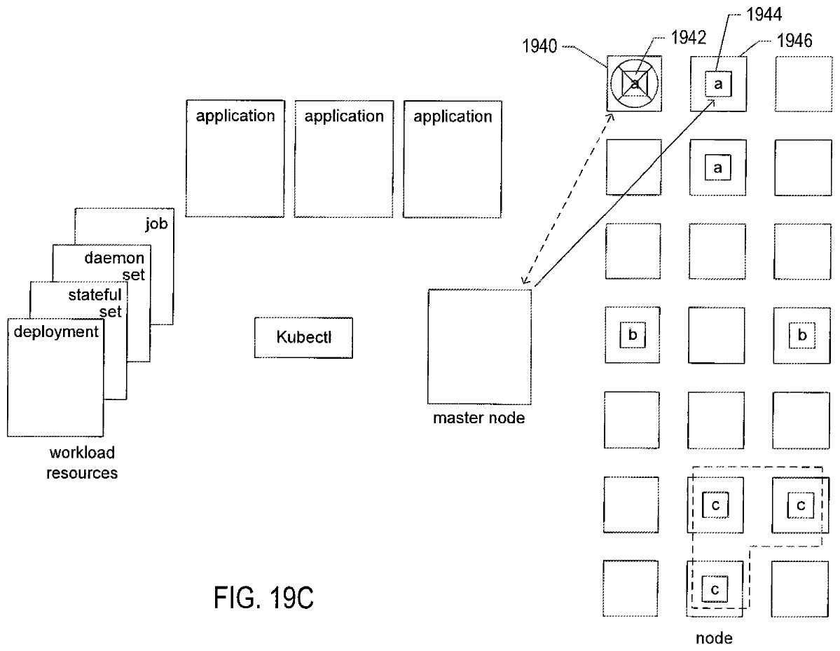

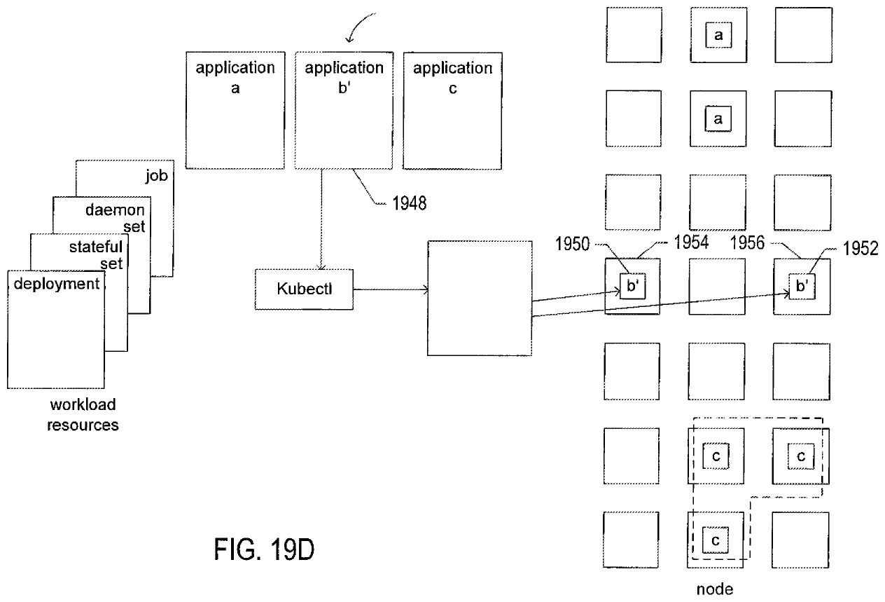

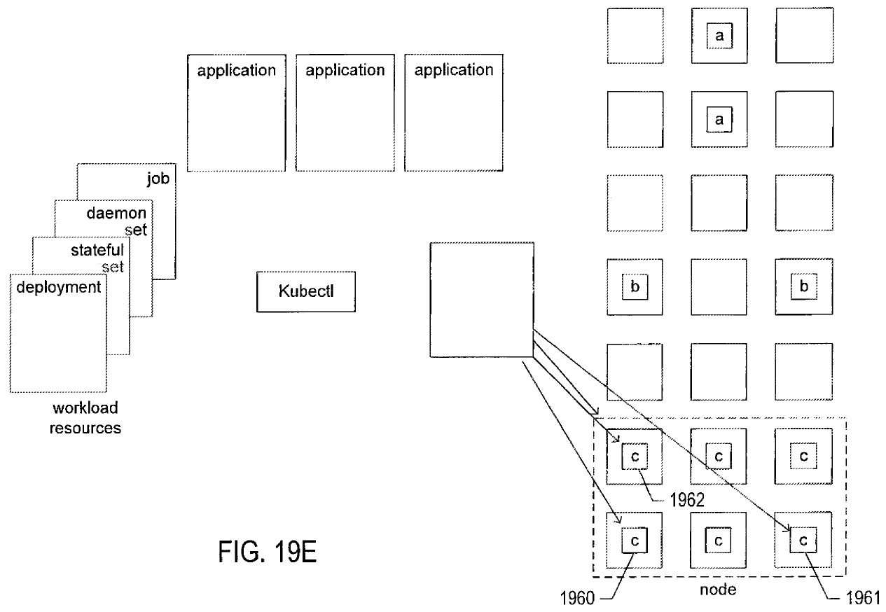

FIGS. 19A-E illustrate operation of a Kubernetes cluster. While there are many ways for a user to access a Kubernetes cluster and Kubernetes-cluster services through the Kubernetes API, a common approach to instantiating containerized applications is to develop a specification, referred to as a “configuration file.” that specifies one or more of various types of workload resources 1902 and to submit the configuration file, along with references to containerized applications 1904-1906, via the Kubectl command line interface 1908 to the Kubernetes API 1910 provided by a Kubernetes-cluster control plane 1912. The Kubernetes-cluster control plane distributes and schedules execution of a set of pods containing containerized-application instances of the containerized applications according to the workload-resource specification. The Kubernetes-cluster control plane then monitors the operational behaviors of the distributed pods over an execution lifetime specified in the workload-resource specification. Thus. the Kubernetes cluster automatically instantiates and manages executable instances of supplied containerized applications according to a workload-resource specification.

There are a number of different types of workload resources. A deployment-and-replicaSet workload resource 1914 is often used for instantiating and managing stateless applications. The Kubernetes control plane manages this type of workload resource, in part. by ensuring that a specified number of pods remain operational for each different type of containerized-application instance specified in the deployment. A statefulSet workload resource 1916 can be used to specify instantiation and management of a set of related pods associated with states. Additional types of workload resources include daemonSets 1918 and jobs 1920. In addition, Kubernetes supports specifying a service abstraction layer that includes a logical set of pods that are exposed to external communications and provided with service-related functionalities, including load-balancing and service discovery.

When, in the example shown in FIGS. 19A-E, the configuration file is input to a Kubernetes system via the Kubectl command line interface 1908. the active master node of the control plane invokes the scheduler to create and distribute pods containing the specified number of containerized-application instances among worker nodes of the cluster as well as to provide additional facilities for sets of pods defined to compose a service. In the example shown in FIG. 19A, two pods containing instances of application a 1822-1923, two pods containing instances of application h 1924-1925, and three pods containing instances of application c 1926-1928, which together compose a service, as indicated by dashed contour 1930, are created according to the input configuration file. As shown in FIG. 19B, the Kubernetes control plate then invokes the controller manager to launch controllers 1932-1935 to monitor operation of the distributed pods which, in turn, launch execution of the containerized applications within the pods according to specifications contained in the configuration file.

FIGS. 19C-E illustrate various types of management operations carried out by the Kubernetes control plate during the lifetime of the workload resources instantiated in FIGS. 19A-B. As shown in FIG. 19C, when a node 1940 that originally hosted an instance of application a fails, as indicated by the “X” symbol 1942, a controller within the Kubernetes control plane detects the failure, after which the Kubernetes control plane creates a new pod to execute an instance of application a 1944 and distributes the new pod to a different. functioning node 1946. As shown in FIG. 19D, when a user supplies a reference to a new version of application b 1948 to the Kubernetes control plane via the Kubectl command line interface 1908. the Kubernetes control plate arranges for two replacement pods 1850 and 1952 containing instances of the new version of application b to be distributed to nodes 1954 and 1956, following which the original pods containing the older version of application b are terminated. As shown in FIG. 19E. when the Kubernetes control plane determines that the current workload associated with the service comprising three pods containing instances of application c (1930 in FIG. 19A) has increased above a specified threshold workload, the Kubernetes control plane automatically scales up this service to include three new pods 1960-1962 to which portions of the excessively high workload can be distributed. Detecting and ameliorating node failures, carrying out updates and upgrades of executing containerized applications. and automatically scaling up and scaling down a deployed workload resource are examples of the many different types of management services and operations provided by a Kubernetes cluster via a set of controllers running within the active management node. Controllers monitor pod operations for occurrences of various types of events and invoke event handlers to handle the events. with each different type of controller monitoring and handling different types of events, The control plane thus dynamically controls the worker nodes in accordance with the configuration file or files that define the configuration and operational behaviors of each workload resource.

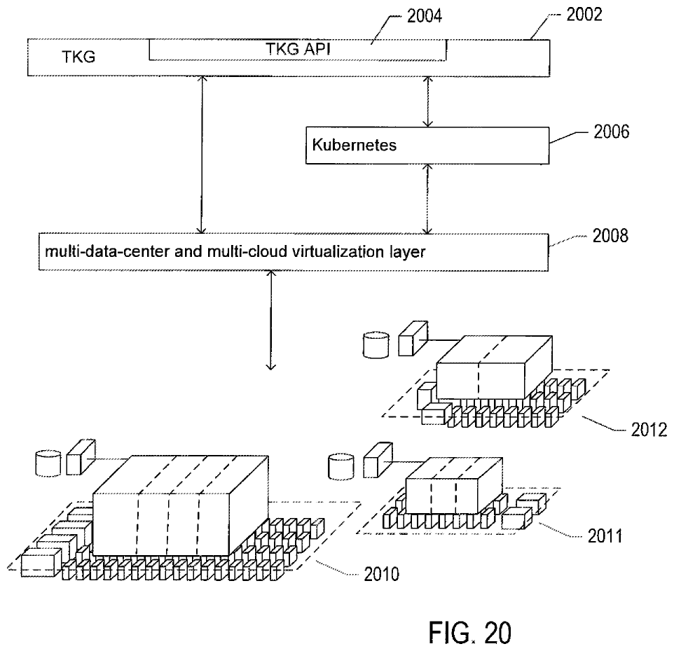

FIG. 20 illustrates the Tanzu Kubernetes Grid (“TKG”) containerized-application orchestration system. TKG is a higher-level orchestration system that automatically instantiates and manages Kubernetes clusters across multiple data centers and clouds. TKG 2002 provides, through a TKG API 2004. similar services and functionality to those provided by Kubernetes. In fact, TKG is layered on top of Kubernetes 2006. However. TKG is also layered above the multi-data-center and multi-cloud virtualization layer 2008. such as the multi-cloud aggregation distributed system discussed above with reference to FIG. 10. This allows TKG to support Kubernetes-like clusters across multiple data centers and cloud-computing facilities 2010-2012. This also allows TKG to migrate nodes among different data centers and cloud-computing facilities and provide additional functionalities that are possible because of TKG's access to services and functionalities provided by the multi-data-center and multi-cloud virtualization layer. In essence. TKG is a meta-level Kubernetes system. Like Kubernetes, TKG uses both a control plane comprising specialized control-plane nodes as well as a set of worker Kubernetes clusters across which TKG distributes workload resources.

### Mobile Network Infrastructure

FIG. 21 illustrates an older-technology mobile network. A mobile network provides radio-frequency voice and data transmissions between user cell phones as well as interconnection of cell phones to the public switched telephone network (“PSTN”) and to packet-based networks on which the Internet is implemented. Mobile networks are complex systems with many different electronic components, including routers, bridges, firewall appliances, and other such components as well as computer-system-implemented components. Mobile networks have steadily evolved to incorporate new, more capable technologies, and different types and generations of mobile networks are currently in service around the world. A typical older-technology mobile network includes a large number of geographical areas, referred to as “cells,” such as hexagonally shaped area 2102, each served by a cellular tower, such as cellular tower 2104. Cells are often hexagonally shaped. but can have other regular shapes, such as squares and circles. The cellular tower is a radio-frequency transceiver that sends radio-frequency signals to, and receives radio-frequency signals from, user cell phones within a relatively small geographical area surrounding the cellular tower, often including the cell containing the cellular tower and adjacent cells. The cellular towers are each connected to a base transceiver station (“BTS”), such as BTS 2106, which act as aggregators or collectors for signals received by the cellular towers connected to the BTS and as distributors of signals forwarded to the BTS by higher-level components of the mobile network for distribution to user cell phones via cellular towers connected to the BTS.

Each BTS is connected to a base station controller (“BSC”). such as BSC 2108. The BSC allocates radio channels, controls handovers between BTSs connected to the BSC when users move from accessing the mobile network through a cellular tower connected to a first BTS to a cellular tower connected to a second BTS, and controls forwarding of signals from the connected BTSs to higher-level components of the mobile network and distribution of signals from the higher-level components of the mobile network to user cell phones via the connected BTSs and cellular towers. The BSC is often implemented using a distributed computing system, including data-storage appliances, along with many types of electrical components. including power supplies, routers, switching circuitry, and many other types of components.

Each BSC is connected to a mobile switching center (“MSC”), such as MSC 2110. An MSC provides circuit-switched calling mobility management, interconnecting mobile calls to the PSTN, interconnecting user mobile devices with the Internet, implementing handovers at the BSC-to-BSC level and facilitating handovers at the MSC level, providing connection to additional services, such as conference calling, generation of billing information, distribution of calls from the PSTN and the mobile network to called user devices, routing and delivering short message service (“SMS”) messages, and accessing various types of stored information related to mobile-network users. mobile-network-user devices, and other types of information. This information may be centrally stored in databases in one or more data centers. such as data center 2112. The dashed circle 2114 in FIG. 21 indicates that. in older-technology mobile networks, signals are generally transmitted through circuit-switched communications networks up to the MSCs and between the mobile network and PSTN while signals are transferred through packet-based networks between MSCs and between MSCs and data centers within the dashed circle.

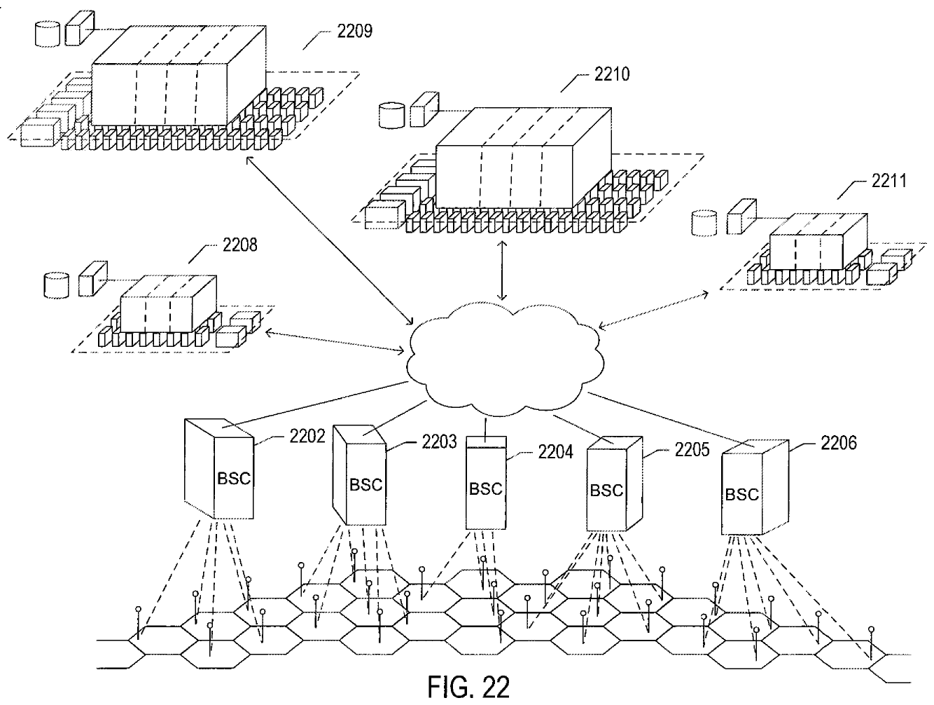

FIG. 22 illustrates newer-technology mobile network based largely on packet-based-network communications. Newer-technology mobile networks extend packet-based-network communications at least as far down as the BSCs 2202-2206 and. in certain cases, even lower. Much of the older-technology electrical components from the BTS/BSC level upwards are implemented as virtual components within data centers and cloud-computing facilities 2208-2211. In essence, much of the complexity of newer-technology mobile networks is implemented in software rather than as discrete electrical and electromechanical appliances and components used in older-technology mobile networks. This provides many advantages to mobile-network-service providers. Data transfer, including digitally-encoded voice data as well as digital data exchanged through the Internet, can be carried out with significantly reduced latencies in packet-based network communications in comparison to circuit-switched network communications. Maintenance costs can be significantly reduced, since most of the complexity of the newer-technology mobile networks resides in mobile-network applications executing within distributed computing systems rather than in large numbers of geographically distributed hardware appliances and electrical components. Incorporation of technology improvements and updating newer-technology mobile networks is far more cost-effective and time efficient for computationally implemented components. In addition, newer-technology mobile networks provide for greater flexibility with respect to the location of virtualized components. It is even possible to dynamically aggregate functionality at higher levels and to disperse aggregated functionality to lower levels in order to optimize use of computational resources and to optimally decrease network latencies. Because of the decreased cell sizes and greatly increased communications bandwidths in fifth-generation (5G) mobile networks, transition to computational implemented components and subsystems is necessary to provide desired levels of performance and service quality.

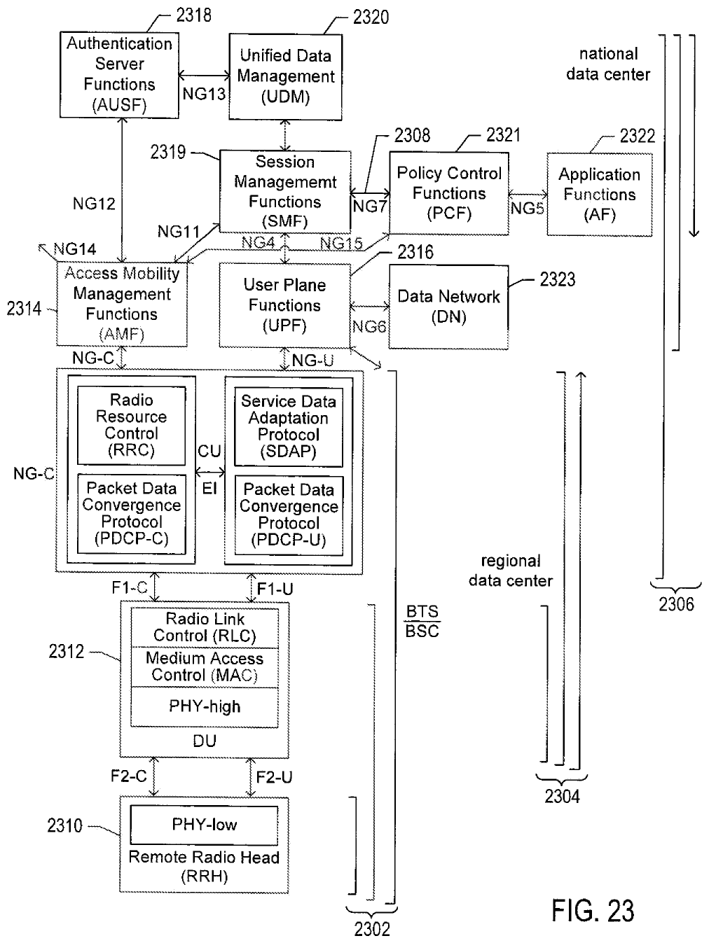

FIG. 23 provides a block diagram for the various logical components of a 5G mobile network. These logical components are implemented as CNFs within data centers and/or as CNFs and cloud-computing facilities. A first set of vertical brackets 2302 indicates the levels of logical components that may be included in the newer-technology BTS BSC base station layer, a second set of vertical brackets 2304 indicates the levels of logical components that may be included in newer-technology regional data centers, and a third set of vertical brackets 2306 indicates the levels of logical components that may be included in a national data center. The range of levels reflects the flexibility with which computationally-implemented mobile-network components can be distributed among national data centers, regional data centers, and BSCs. In FIG. 23. logical components are represented as rectangles, some of which include smaller rectangles representing protocols used for data exchange between component layers and levels. Interfaces between components are indicated by double headed arrows, such as double headed arrow 2308.

The lowest level component shown in FIG. 23 is the remote radio head (“RRH”) 2310. This component connects a radio-frequency transceiver with the lower-level mobile-network protocol stack. A distributed unit 2312 is the next lowest level component. and implements a protocol stack including the medium access control (“MAC”) and radio link control (“RLC” protocols. The next level component is referred to as the central unit (“CU”). The central unit includes a control-plane protocol stack and a user-plane protocol stack that interface to the access mobility management functions (“AMF”) 2314 and the user plane functions (“UPF”) 2316 logical components. respectively. The CU and DU together provide the functionality of the base station and the higher-level components together compose the 5G core functionality implemented as VNFs and CNFs within regional and national data centers. The AMF 2314 is responsible for many different functionalities. including registration management, mobility management, SM message transport, authentication and authorization. SMS-message transport, and many other functionalities. The UPF 2316 is responsible for packet routing and forwarding, traffic uses reporting. packet buffering, and other such functionality. The AMF and UPF logical components interface to numerous additional logical components 2318-2323.

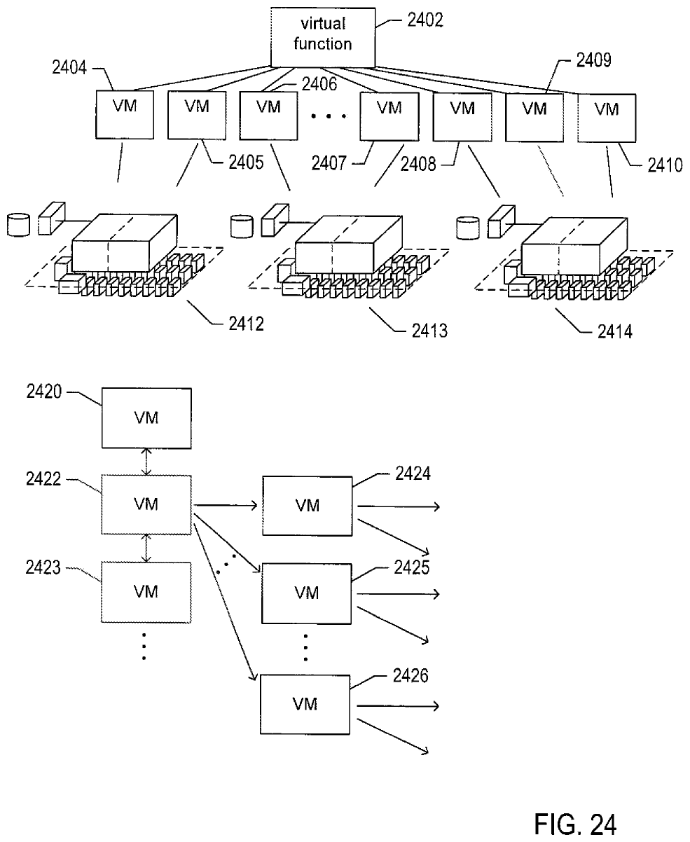

FIG. 24 illustrates the nature of VNF and CNF implementations. A virtual function 2402, such as an access mobility management function, may be implemented as multiple instances of a containerized mobile-network application running within multiple virtual machines 2404-2410 or physical servers. The virtual machines or physical servers may be distributed across one or more data centers or cloud-computing facilities 2412-2414. A given instance of a mobile-network application running within a virtual machine 2420 may interface to many additional virtual functions implemented as mobile-network-application instances within virtual machines 2422-2423, each of which may, in turn, interface to yet more virtual functions and virtual-network components implemented as mobile-network-application instances within virtual machines 2424-2426. Thus, newer-technology mobile networks are implemented as complex meshes of many different types of containerized-mobile-network-application instances distributed across many different data centers and/or cloud-computing facilities as well as distributed computing systems located within base stations. Depending on the particular implementation, a given data center or cloud-computing facility may include a very different set of VNFs and CNFs than other of the data centers and cloud-computing facilities that together implement a mobile network. Furthermore, because many of the VNFs and CNFs are directly concerned with receiving and transmitting very large volumes of digital voice-message packets and data packets from user cell phones to mobile-network components and from mobile-network components to user cell phones, and because the transmission of data packets are associated with high-throughput and low-latency performance requirements and constraints, many of the mobile-application instances are required to execute on physical computing platforms, such as servers. with specific hardware, operating-system, and hypervisor configurations and facilities. These specific hardware. operating-system, and hypervisor configurations and the facilities are obtained both by customization through software installation and configuration as well as by instantiating mobile-application instances within physical servers or virtual machines running on physical servers that meet the specific hardware requirements of the mobile-application instances. The scale and complexity of a mobile-network implementation therefore represents difficult technical challenges with respect to instantiating a mobile network within multiple distributed-computing facilities as well as managing the mobile-network implementation. over time.

### Current Cloud-Based Mobile-Network-Infrastructure Instantiation and Management

As mentioned in the preceding subsection, mobile-application instances that implement VNFs and CNFs are often associated with specific requirements for the execution environments in which they are deployed. FIG. 25 illustrates the nature of certain mobile-network-application-execution-environment requirements. The outer rectangle 2502 in FIG. 25 represents a server or other physical computer system that includes a hardware layer 2504, a firmware level 2506, a virtualization layer 2508. a guest-operating-system layer 2510, and an application layer 2512. The application layer and guest-operating-system layer together represent an application-execution environment provided by a virtual machine, as discussed in preceding subsections. Execution of a particular containerized-mobile-network application instance 2514 may require post-deployment installation of a particular plug-in 2516 to extend the functionality of the application instance. In addition, proper execution of the application may depend on the guest operating system including one or more specific operating-system features 2518 and/or a particular configuration of the guest operating system via parameter settings 2520 or other types of customizations. Similarly, proper execution of the application may depend on particular virtualization-layer features 2522 and/or configurations 2524 as well as firmware configurations 2526, such as a specific basic input-output system (“BIOS”) configuration. Examples include named data networking forwarding (“NFD”) daemons, Huge Pages virtual-memory-management features, single-route I/O virtualization (“SR-IOV”) features, real-time-kernel OS features. and virtualization-layer features that allow reservation of CPU and memory resources for particular virtual machines. Finally, proper execution of the application instance may require particular hardware components and features 2528, such as field programmable gate arrays (“FPGAs”), graphical processing units (“GPUs”), and precision-time-protocol (“PTP”) real-time clocks, and may also require virtualization-layer pass-throughs 2530 that allow exclusive access by the guest operating system to particular hardware components 2532.

FIGS. 26A-H illustrate a current approach to instantiating and managing a mobile network implemented as CNFs and VNFs in multiple distributed computing systems, data centers, and/or cloud-computing facilities. FIG. 26A shows the logical components of a telco-cloud-automation (“TCA”) mobile-network orchestration system. The TCA 2602 is responsible for using input mobile-network-infrastructure specifications to instantiate the VNFs, CNFs, and additional computational infrastructure that together compose a mobile network. In addition, the TCA monitors the mobile-network infrastructure. over the lifetime of the mobile networking, to ensure that the infrastructure continues to operate according to the input mobile-network-infrastructure specifications as well as to update the mobile network in order to employ latest versions of mobile-network applications and to adjust the mobile-network infrastructure in order to maintain specified levels of service and cost-effective operation. The TCA operates as a meta-level orchestration system with specific functionality to address the operational requirements and complexities of mobile-network infrastructure.

The TCA employs the above-described TKG orchestration system 2604 to instantiate workloads across multiple data centers and cloud-computing facilities. As discussed above, the TKG, in turn, employs the Kubernetes orchestration system 2606 as well as a multi-data-center and multi-cloud virtualization layer 2608. The TCA, along with the TKG orchestration system, virtualization layer. and the Kubernetes orchestration system. instantiates and manages a mobile network based on the VNFs and CNFs 2610 distributed across multiple distributed computer systems, data centers, and/or cloud-computing facilities 2612-2614.

FIGS. 26B-G illustrates instantiation of a mobile network by the TCA. As shown in 26B, the TCA receives a mobile-network specification 2616 from which it generates a set of one or more workload-resource specifications 2618, or configuration files, that the TCA users to invoke the TKG 2604 to instantiate a set of Kubernetes clusters 2620 distributed across the multiple distributed-computing systems. data centers, and/or cloud-computing facilities. Arrows 2622-2629 indicates that the TKG relies on the services and functionalities of the virtualization layer 2608 and the Kubernetes orchestration system 2606 to instantiate the Kubernetes clusters.

Next, as shown in FIG. 26C, the TCA employs services and functionalities of the TKG and virtualization layer. as indicated by arrows 2630 and 2631. to determine whether the Kubernetes clusters can provide worker nodes with the mobile-network-specific hardware. firmware, virtualization-layer, operating-system. and other configurations. components, and facilities, discussed above with reference to FIG. 25. Determining whether the Kubernetes clusters can provide worker nodes with the required mobile-network-specific configurations, components, and facilities involves direct access, by the TCA, to virtualization-layer functionalities. While it is possible to specify various high-level requirements through the TKG and Kubernetes APIs, such as persistent-storage capacities, networking bandwidth, and processing bandwidths, the TKG and Kubernetes APIs do not provide functionality for specifying detailed mobile-network-specific configurations, components, and facilities required for hosting mobile-network application instances. The TCA may need to carry out a lengthy interaction with the TKG to obtain a suitable set of Kubernetes clusters.

Next, as indicated by arrow 2632 in FIG. 26D, the TCA instructs the TKG to provision worker nodes 2634 among the Kubernetes clusters. The worker nodes are provisioned to meet specified requirements for CPU bandwidth, memory capacity. and other such requirements via constraints and node affinities that can be imposed through the TKG API, but, as shown in FIG. 26E. the TCA again needs to directly interact with the virtualization layer, as indicated by arrow 2636. with the TKG, as indicated by arrow 2638, and directly with worker nodes, as indicated by arrows 2640-2642, in order to ensure that the provisioned worker nodes have the mobile-network-specific configurations, facilities, and components required for mobile-network operation. When the TCA directly interact with the virtualization layer and provisioned worker nodes in order to ascertain whether or not they have the mobile-network-specific configurations. facilities, and components, the TCA may need to employ secure communications connections to the worker nodes. In view of the fact that there may be thousands, tens of thousands. or more worker nodes provisioned for a mobile network. direct access, by the TCA, to the virtualization-layer and provisioned worker nodes represents a significant computational and temporal overhead.

Next, as shown in FIG. 26F. the TCA interacts directly with the virtualization Byer, as represented by arrow 2644 and 2646-2648, to customize worker nodes to have the configurations and facilities required for operation of the mobile networks. This may involve downloading and installing plug-ins and pass-throughs, and interfacing to the virtualization layer and guest operating system in order to configure the worker nodes. Again, these operations may involve establishment of secure connections between the TCA and worker nodes and may involve multiple operations and at least temporarily storing data returned from operations needed to carry out subsequent operations. Worker-node customization represents an even greater computational and temporal overhead than the initial verification of worker-node capabilities discussed above with reference to FIG. 26E. Finally. as shown in FIG. 26G. the mobile-network application instances that together implement the VNFs, CNFs. and other computational support for the mobile-network infrastructure are launched via the TKG.

Once the mobile-network infrastructure is up and running, the TCA cooperates with the TKG and a virtualization layer to monitor and manage the mobile-network computational infrastructure. As one example, when, due to increased bandwidth requirements, certain of the mobile-network applications are scaled up to include additional worker nodes, the TCA needs to cooperate with the TKG and virtualization layer to make sure that the new worker nodes are properly customized and provide the required hardware components, configurations, and facilities to implement mobile-network components. This again represents a very large and ongoing temporal and computational overhead, requiring establishment of secure communications connections and often requiring multiple, successive operations and interactions between the TCA, virtualization layer, and worker nodes. Thus, while the current TCA implementations provide highly useful and desirable orchestration functions, the very tight coupling between the TCA, TKG, and virtualization layer introduces significant complexities and the implementation of the TCA and involves very large, ongoing computational and temporal overheads.

### Currently Disclosed Methods and Systems

The currently disclosed methods and systems are directed to an improved TCA that instantiates and manages mobile-network infrastructure without tight coupling and interdependencies with the underlying TKG and virtualization layers. FIGS. 27A-D illustrate operation of the improved TCA using illustration conventions employed in FIGS. 26A-H, discussed above in the previous subsection of this document. As shown in FIG. 27A, a mobile-network specification 2702 is input to the improved TCA 2704, as to the original TCA in FIG. 26A. However, the improved TCA prepares both a node policy 2706 as well as one or more workload-resource specifications 2708 based on the input mobile-network specification 2702. The node policy 2706 specifies the various mobile-network-specific configurations, facilities. and components required for different types of worker nodes to be provisioned in order to implement the mobile-network computational infrastructure. The workload-resource specifications 2708 provide the information, along with the node policy, that is used by the TKG to instantiate and manage the mobile-network computational infrastructure. In addition, as represented by arrow 2710, the TCA uses TKG operator-provisioning facilities to extend TKG functionality by introducing two new operators into the TKG. These include a VmConfig operator that is provisioned into the TKG control plane and a NodeConfig operator that is provisioned into the TKG workload clusters. The VmConfig operator includes logic for processing the node policy 2706 in order to generate custom-resource definitions and custom resources that extend the workload resources specified by the workload-resource specifications 2708. VmConfig operator contains the logic that implements the custom-resource extensions. including logic for interacting with the virtualization layer to provision worker nodes within worker nodes having hardware components specified in the node policy, logic for interacting with the virtualization layer to customize provisioned worker nodes to have the mobile-network-specific configurations and facilities specified in the node policy. logic for interacting with a virtualization layer in order to carry out various types of management operations provided by the TKG with respect to the custom resources, including scale out, worker-node deployment, version updates, and other such management operations. In addition, the VmConfig operator extends the TKG to persist configuration data related to the custom resources and provide the data, as needed, to the NodeConfig operators provisioned within TKG workload clusters. The NodeConfig operators perform node-customization operations related to virtual machines during instantiation and during management operations carried out by the TKG. The extended TKG then receives the node policy 2706 and workload resource specifications and provisions TKG manager nodes 2712 across the distributed-computer systems, data centers, and/or cloud-computing facilities, each TKG manager node extended via inclusion of the VmConfig operator.

As shown in FIG. 2713. the TKG manager nodes generate custom resources 2714-2717, provision TKG workload clusters 2718-2721 across the distributed-computing systems. data centers, and/or cloud-computing facilities, each TKG workload cluster provisioned with the NodeConfig operator. The TKG managers then direct the TKG clusters, using the custom resources, to provision the worker nodes 2730 needed for implementation of the mobile-network computational infrastructure. The VmConfig and NodeConfig operators extend the TKG to access virtualization-layer functionality in order to ensure that the provisioned worker nodes have the mobile-network-specific components, configurations, and facilities, specified in the node policy, to support the mobile-network application instances that they are provisioned to execute. Thus, unlike in the currently available TCA implementations, the improved TCA is not involved in deploying and scheduling TKG workload clusters and worker nodes. Instead, the TKG has been extended, by incorporation of the VmConfig and NodeConfig operators, to provision and customize the mobile-network computational infrastructure, without participation of the improved TCA. The improved TCA therefore acts as a meta-level orchestrator that first extends the underlying TKG for orchestration of mobile-network-specific deployments and then generates the configurations and node policy needed by the extended TKG to instantiate and manage a mobile-network computational infrastructure. The extended TKG carries out the instantiation and management tasks independently from the TCA. As shown in FIG. 27D, once the mobile-network computational infrastructure is instantiated and operating, ongoing management operations are carried out entirely by the extended TKG. In essence, the currently disclosed methods and systems provide an improved TCA that carries out TKG extension. via TKG operators, in an initial set of operations that allow the TCA to avoid the large computational and temporal overheads incurred by current TCA implementations, which interoperate with the TKG virtualization layer during mobile-network-computational-infrastructure instantiation and management.

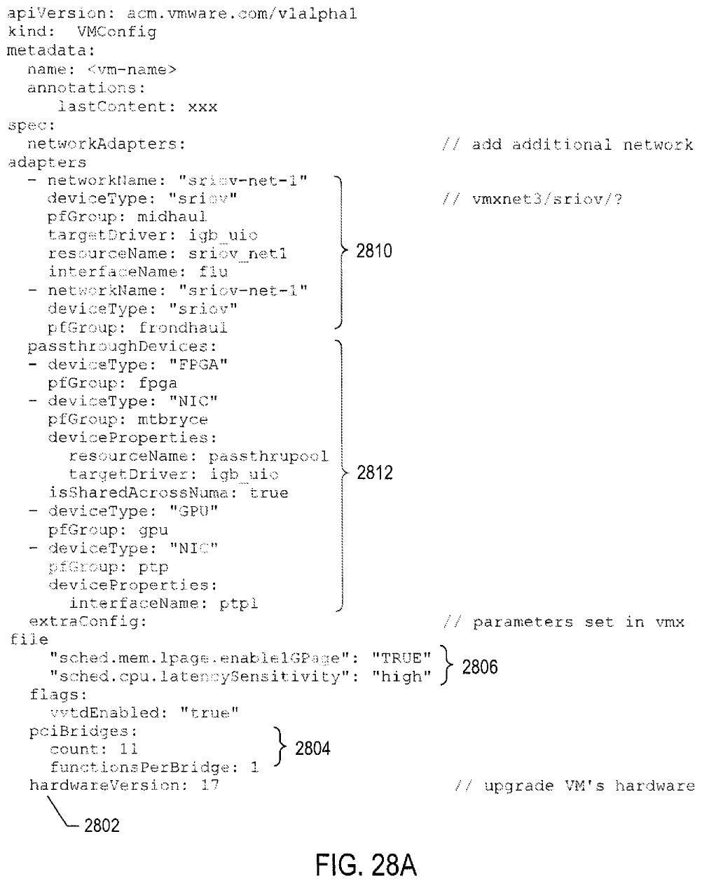

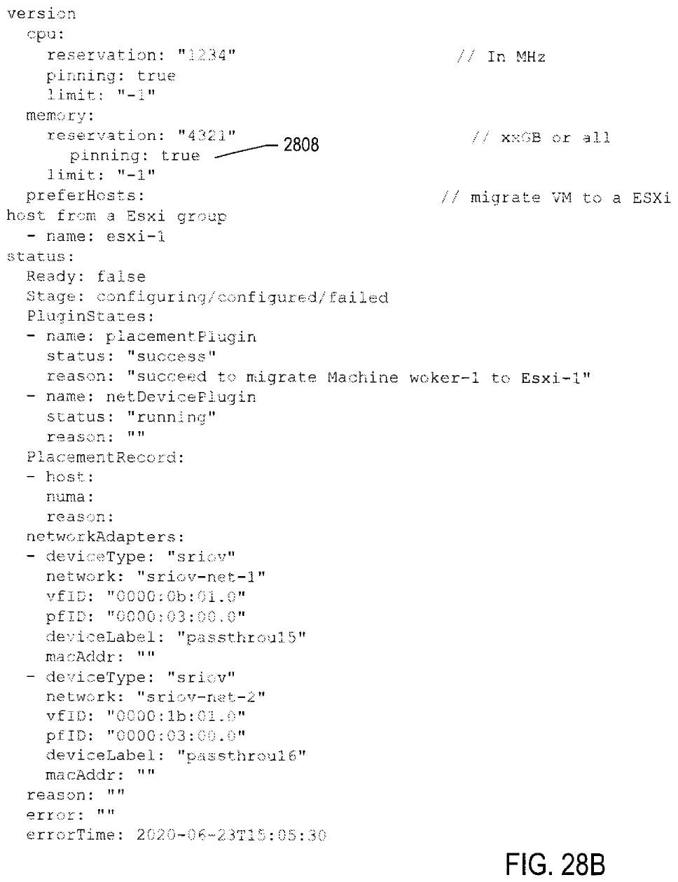

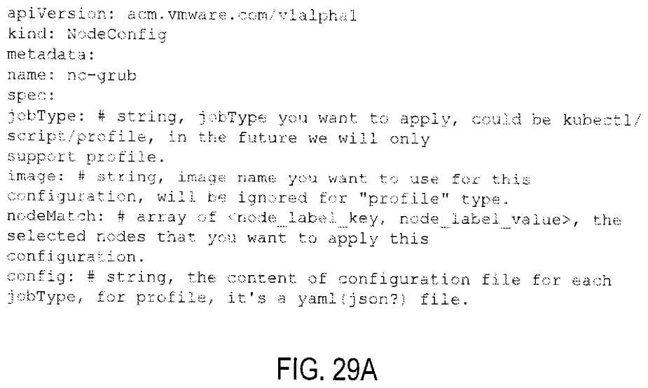

FIGS. 28A-B show an example VMConfig custom resource definition. As discussed above, the VMConfig operator is associated with one or more controllers that facilitate instantiation mobile-network-specific pods for execution of mobile-network-specific applications, by mobile-network-specific worker nodes, that implement many different VNFs, CNFs. and/or virtual network components. In addition, the one or more controllers associated with the VMConfig operator facilitate monitoring execution of the mobile-network-specific pods during their execution life times, detecting and responding to various different events. The controllers are responsible for ensuring that mobile-network-specific worker nodes are mapped, by the TKG virtualization layer, to physical computer systems having the necessary hardware components and configuring and provisioning the mobile-network-specific worker nodes. The VMConfig operator processes one or more node policies input by the improved TCA to generate one or more custom resource definitions specify one or more custom resources corresponding to mobile-network-specific applications that implement the VNFs, CNFs, and/or virtual network components of a mobile-network infrastructure.

Line 2802 in FIG. 28A specifies a particular VM hardware version. A controller associated with the VMConfig operator determines whether or not a TKG worker node provisioned by TKG for execution of a mobile-network-specific application is configured to the specified VM hardware version. If not, the controller determines whether the TKG worker node is mapped to a server that supports the specified VM hardware version. If so, then the TKG worker node is upgraded to the specified VM hardware version. If not, then steps are taken to identify another available worker node that supports the specified VM hardware version. Lines 2804 in FIG. 28A specify the number of required PCI bridges and the number of functions per PCI bridge. A controller associated with the VMConfig operator ensures that a TKG worker node provisioned by TKG for execution of a mobile-network-specific application is properly configured with the specified number of PCI bridges and properly configured. Lines 2806 specify parameter settings for a VMkernel process that manages 110 to and from certain classes of devices. Line 2808 specifies memory pinning and, along with lines 2806, which ensures that a mobile-network-specific VM is non-uniform-memory-access (“NUMA aligned”) without CPU pinning. Lines 2810 specified various required network adapters and lines 2012 specify various pass-through devices. There is other parameters, constraints, and requirements can be found in the example VMConfig custom resource definition.

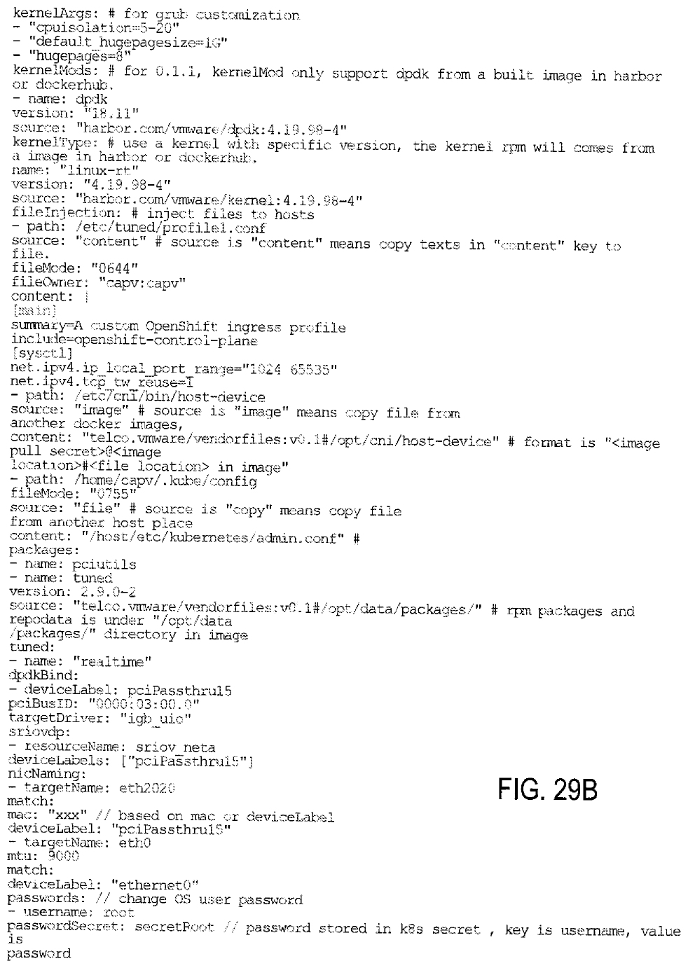

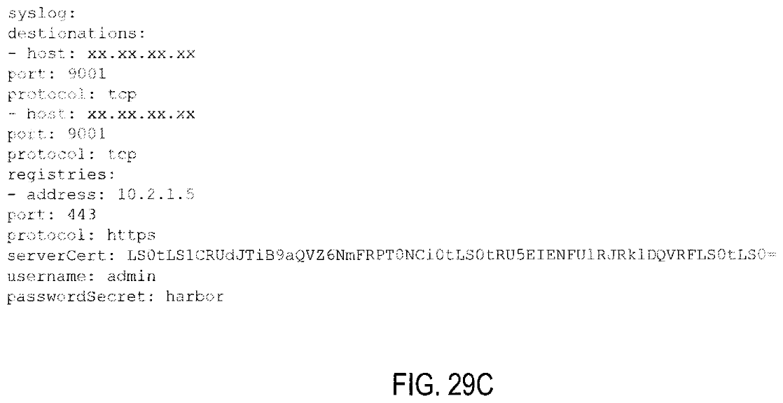

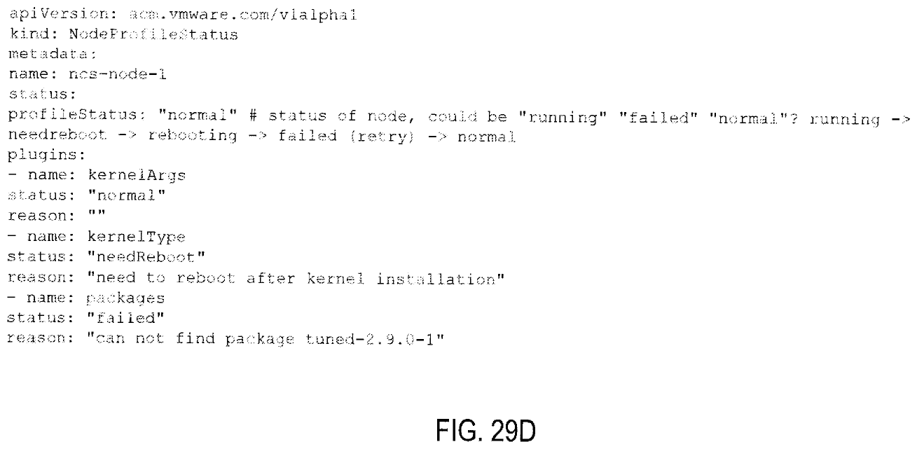

FIGS. 29A-D show an example of a NodeConfig custom resource definition. FIG. 29A shows a custom resource definition, FIGS. 29B-C show a profile definition for nodes. and FIG. 29D shows a NodeConfig status custom resource definition. As discussed above, each TKG workload cluster is provisioned with a NodeConfig operator. The NodeConfig operator facilitates proper configuration and monitoring of mobile-network-specific pods and mobile-network-specific nodes on which they run.

The present invention has been described in terms of particular embodiments, it is not intended that the invention be limited to these embodiments. Modifications within the spirit of the invention will be apparent to those skilled in the art. For example. any of many different implementations of the mobile-network-infrastructure orchestration system can be obtained by varying various design and implementation parameters, including modular organization, control structures, data structures. hardware. operating system, and virtualization layers, and other such design and implementation parameters. Alternative implementations of the mobile-network-infrastructure orchestration system receive and process mobile-network-computational-infrastructure specifications with different formats, vocabularies, and syntaxes. Node policies may also have different formats, vocabularies, and syntaxes, depending on the implementation. The currently disclosed mobile-network-infrastructure orchestration system can be implemented to incorporate a variety of different types of orchestration subsystems and virtualization systems that aggregate multiple distributed computer systems and facilities.

1. A mobile-network-infrastructure orchestration system comprising:
one or more processors;
one or more memories;
one or more data-storage devices; and
processor instructions, contained in executable files stored in one or more of the one or more data-storage devices, that when executed by one or more of the one or more processors, control the mobile-network-infrastructure orchestration system to
receive a mobile-network-computational-infrastructure specification;
extend a containerized-application orchestration system to include functionality needed to instantiate and manage mobile-network-specific worker nodes within workload clusters distributed across multiple distributed-computer systems aggregated by a virtualization layer;
generate one or more workload-resource specifications and a node policy from the mobile-network-computational-infrastructure specification; and
input the one or more workload-resource specifications and node policy to launch instantiation and subsequent management of a mobile-network computational infrastructure by the extended containerized-application orchestration system.

2. The mobile-network-infrastructure orchestration system of claim 1 wherein the mobile-network computational infrastructure comprises virtual network functions and/or cloud-native network functions implemented on worker nodes provisioned on worker nodes within workload clusters distributed across multiple distributed-computer systems.

3. The mobile-network-infrastructure orchestration system of claim 1 wherein the multiple distributed-computer systems include distributed computer systems that implement mobile-network base stations, regional data venters, and national datacenters.

4. The mobile-network-infrastructure orchestration system of claim 1 wherein the multiple distributed-computer systems include data centers and cloud-computing facilities.

5. The mobile-network-infrastructure orchestration system of claim 1 wherein the mobile-network-infrastructure orchestration system extends the containerized-application orchestration system to include functionality needed to instantiate and manage mobile-network-specific worker nodes within workload clusters distributed across multiple distributed-computer systems by provisioning the containerized-application orchestration system with one or more control-plane operators and one or more workload-cluster operators.

6. The mobile-network-infrastructure orchestration system of claim 5 wherein the functionality needed to instantiate and manage mobile-network-specific worker nodes within workload clusters distributed across multiple distributed-computer systems includes:
worker-node-information-extraction routines that access worker nodes through the virtualization layer to determine characteristics and parameters of the worker nodes, including the hardware components, hardware configuration, firmware configuration, operating-system configuration, and installed applications; and
worker-node customization routines that configure worker nodes.

7. The mobile-network-infrastructure orchestration system of claim 6 wherein the worker-node customization routines:
install plugins specified in the node policy;
install passthroughs specified in the node policy;
download downloadable components specified in the node policy; and
alter operating-system, firmware. and local-virtualization-layer settings. parameters, and configurations as specified in the node policy.

8. The mobile-network-infrastructure orchestration system of claim 6 wherein the one or more control-plane operators:
process the node policy to determine mobile-network-specific components. functionalities, and configurations needed by worker nodes; and
create custom resources corresponding to worker nodes that embody the mobile-network-specific components. functionalities. and configurations needed by worker nodes;
call worker-node-information-extraction routines to match workload cluster nodes to custom resources during management operations carried out by the extended containerized-application orchestration system, including scheduling and deployment of mobile-application instances and node-replacement. scaling, and update operations;
call worker-node customization routines to customize hardware, firmware, local-virtualization-layer, and operating-systems within worker nodes during management operations carried out by the extended containerized-application orchestration system, including scheduling and deployment of mobile-application instances and node-replacement and scaling operations; and
persist worker-node configuration information and pass worker-node configuration information to workload-cluster operators.

9. The mobile-network-infrastructure orchestration system of claim 6 wherein the one or more workload-cluster operators call worker-node customization routines to customize virtual machines within worker-nodes during management operations carried out by the extended containerized-application orchestration system.

10. A method that instantiates and manages a mobile-network computational infrastructure. the method comprising:
receiving a mobile-network-computational-infrastructure specification:
extending a containerized-application orchestration system to include functionality needed to instantiate and manage mobile-network-specific worker nodes within workload clusters distributed across multiple distributed-computer systems aggregated by a virtualization layer;
generating one or more workload-resource specifications and a node policy from the mobile-network-computational-infrastructure specification; and
inputting the one or more workload-resource specifications and node policy to launch instantiation and subsequent management of a mobile-network computational infrastructure by the extended containerized-application orchestration system.

11. The method of claim 10 wherein the mobile-network computational infrastructure comprises virtual network functions and/or cloud-native network functions implemented on worker nodes provisioned on worker nodes within workload clusters distributed across multiple distributed-computer systems.

12. The method of claim 10 wherein the multiple distributed-computer systems include distributed computer systems that implement mobile-network base stations, regional data venters, and national datacenters.

13. The method of claim 10 wherein the multiple distributed-computer systems include data centers and cloud-computing facilities.

14. The method system of claim 10 wherein extending the containerized-application orchestration system to include functionality needed to instantiate and manage mobile-network-specific worker nodes within workload clusters distributed across multiple distributed-computer systems further comprises provisioning the containerized-application orchestration system with one or more control-plane operators and one or more workload cluster operators.

15. The method of claim 10 wherein the functionality needed to instantiate and manage mobile-network-specific worker nodes within workload clusters distributed across multiple distributed-computer systems includes:
worker-node-information-extraction routines that access worker nodes through the virtualization layer to determine characteristics and parameters of the worker nodes, including the hardware components, hardware configuration, firmware configuration, operating-system configuration, and installed applications; and
worker-node customization routines that configure worker nodes.

16. The method of claim 10 wherein the worker-node customization routines:
install plugins specified in the node policy:
install passthroughs specified in the node policy:
download downloadable components specified in the node policy: and
alter operating-system, firmware, and local-virtualization-layer settings, parameters, and configurations as specified in the node policy.

17. The method of claim 16 wherein the one or more control-plane operators:
process the node policy to determine mobile-network-specific components. functionalities. and configurations needed by worker nodes; and
create custom resources corresponding to worker nodes that embody the mobile-network-specific components, functionalities, and configurations needed by worker nodes:
call worker-node-information-extraction routines to match workload cluster nodes to custom resources during management operations carried out by the extended containerized-application orchestration system, including scheduling and deployment of mobile-application instances and node-replacement, scaling. and update operations;
call worker-node customization routines to customize hardware, firmware, local-virtualization-layer, and operating-systems within worker nodes during management operations carried out by the extended containerized-application orchestration system, including scheduling and deployment of mobile-application instances and node-replacement and scaling operations; and
persist worker-node configuration information and pass worker-node configuration information to workload-cluster operators.

18. The method of claim 17 wherein the one or more workload-cluster operators call worker-node customization routines to customize virtual machines within worker-nodes during management operations carried out by the extended containerized-application orchestration system.

19. A physical data-storage device that stores computer instructions that, when executed by processors within a computer system. control the computer system to instantiate and manage a mobile-network computational infrastructure by:
receiving a mobile-network-computational-infrastructure specification;
extending a containerized-application orchestration system to include functionality needed to instantiate and manage mobile-network-specific worker nodes within workload clusters distributed across multiple distributed-computer systems aggregated by a virtualization layer;
generating one or more workload-resource specifications and a node policy from the mobile-network-computational-infrastructure specification; and
inputting the one or more workload-resource specifications and node policy to launch instantiation and subsequent management of a mobile-network computational infrastructure by the extended containerized-application orchestration system.
